(19) United States
(12) Patent Application Publication
(10) Pub. No.: US 2015/0146779 A1
(43) Pub. Date: May 28, 2015

(54) IN-LOOP FILTERING METHOD AND APPARATUS USING SAME

(71) Applicants: ELECTRONICS AND TELECOMMUNICATIONS RESEARCH INSTITUTE, Daejeon (KR); UNIVERSITY-INDUSTRY-COOPERATION GROUP OF KYUNG HEE UNIVERSITY, Yongin-si (KR)

(72) Inventors: Gun Bang, Daejeon (KR); Won Sik Cheong, Daejeon (KR); Nam Ho Hur, Daejeon (KR); Kyung Yong Kim, Suwon-si (KR); Gwang Hoon Park, Seongnam-si (KR)

(73) Assignees: ELECTRONIC AND TELECOMMUNICATIONS RESEARCH INSTITUTE, Daejeon (KR); UNIVERSITY-INDUSTRY COOPERATION GROUP OF KYUNG HEE UNIVERSITY, Yongin-si (KR)

(21) Appl. No.: 14/399,823

(22) PCT Filed: Jul. 17, 2013
(86) PCT No.: PCT/KR2013/006401

§ 371 Date: Nov. 7, 2014

(30) Foreign Application Priority Data
Jul. 17, 2012 (KR) 10-2012-0077592
Jul. 17, 2013 (KR) 10-2013-0084336

(51) Int. Cl. H04N 19/82; H04N 19/176; H04N 19/593

(52) U.S. Cl. CPC H04N 19/82; H04N 19/593; H04N 19/176
USPC 375/240.12

(57) ABSTRACT

A video decoding method for depth information in accordance with an embodiment of the present invention includes generating a prediction block of a current block for the depth information, generating a restored block of the current block based on the prediction block, and performing filtering on the restored block, whether or not to perform the filtering can be determined based on block information about the current block and coding information about the current block.

### TECHNICAL FIELD

The present invention relates to the coding and decoding processing of video and, more particularly, to a video in-loop filtering method and an apparatus using the same.

### BACKGROUND ART

As broadcasting service having High Definition (HD) resolution is recently extended locally and worldwide, many users are being accustomed to video having high resolution and high picture quality. Accordingly, many institutes are giving impetus to the development of the next-generation image devices. Furthermore, in line with a growing interest in Ultra High Definition (UHD) having resolution 4 times higher than HDTV along with HDTV, there is a need for compression technology for video having higher resolution and higher picture quality.

In order to compress video, inter-prediction technology in which a value of a pixel included in a current picture is predicted from temporally anterior pictures or posterior pictures or both, intra-prediction technology in which a value of a pixel included in a current picture is predicted based on information about a pixel included in the current picture, and entropy coding technology in which a short sign is assigned to a symbol having high frequency of appearance and a long sign is assigned to a symbol having low frequency of appearance can be used.

Video compression technology includes technology in which a constant network bandwidth is provided in an environment in which hardware limitedly operates without taking a flexible network environment into consideration. In order to compress video data applied to a network environment including a frequently changing bandwidth, new compression technology is necessary. To this end, a scalable video coding/decoding method can be used.

Meanwhile, 3-D video provides a user with a 3-D effect, such as an effect seen and felt in the real world, through a 3-D stereoscopic display device. As a research related to the 3-D video, a 3-D video standard is in progress in the MPEG of ISO/IEC that is a video standardization organization. The 3-D video standard includes an advanced data format which can support the play, etc. of both a stereoscopic image and an auto stereoscopic image using a real image and its depth information map and a standard for techniques related to the advanced data format.

FIG. 1 is a diagram showing a basic structure and data format of a 3-D video system. FIG. 1 shows an example of a system that is now taken into consideration in a 3-D video standard.

As shown in FIG. 1, the transmission side (i.e., 3D content production side) obtains N(N2)-view video content through the setup of a stereo camera, a depth information camera, and multi-view cameras and the conversion of a 2-D image into a 3-D image (2D/3D conversion).

The obtained video content can include information about the N-view video (N×Video), information about a depth information map (i.e., depth-map), and supplementary information related to the cameras.

The N-view video content is compressed using a multi-view video coding method. A compressed bit stream is transmitted to a terminal through, for example, Digital Video Broadcasting (DVB) over a network.

The reception side restores the N-view video by decoding the received bit stream using a multi-view video decoding method (i.e., depth-image-based rendering).

The restored N-view video is produced into virtual view images having N views or more through a Depth-Image-Based Rendering (DIBR) process.

The virtual view images having N views or more are played according to various stereoscopic display devices (e.g., 2-D display, M-View 3-D display, and head-tracked stereo display), thus providing a user with video having a 3-D effect.

The depth information map used to generate the virtual view images is obtained by representing a distance between a camera and a real object in the real world (i.e., depth information corresponding to each pixel with the same resolution as that of a real image) by a specific number of bits.

FIG. 2 is a diagram showing a depth information map for an image ‘balloons’ that is being used in the 3-D video coding standard for MPEG, that is, an international standardization organization.

FIG. 2(a) shows a real image for an image ‘balloons’, and FIG. 2(b) shows a depth information map for the image ‘balloons’. In FIG. 2(b), depth information is represented by 8 bits per pixel.

FIG. 3 is a diagram showing an example of an H.264 coding structure. The H.264 coding structure has been known to have the best coding efficiency, from among video coding standards developed so far in order to code a depth information map.

Referring to FIG. 3, a unit on which data is processed in the H.264 coding structure is a macro block of 16×16 pixels in width and height. In the H.264 coding structure, video is received, coding is performed on the received video in an intra-mode or an inter-mode, and a bit stream is outputted as a result of the coding.

In the intra-mode, a switch switches to the intra-mode. In the inter-mode, the switch switches to the inter-mode. In a major flow of a coding process, first, a prediction block for a received block picture is produced. A difference between the received block and the prediction block is obtained and then coded.

First, the generation of the prediction block is performed in accordance with the intra-mode and the inter-mode.

In the intra-mode, in an intra-prediction process, the prediction block is generated through spatial prediction using values of already coded pixels that neighbor a current block.

In the inter-mode, in a motion estimation process, a region best matched with a received block is searched for in a reference picture stored in a reference picture buffer, a motion vector is obtained using the region, and the prediction block is generated by performing motion compensation using the obtained motion vector.

As described above, a difference between the received block and the prediction block is obtained, a difference block is generated using the difference, and coding is performed on the difference block.

A method of coding a block is basically divided into the intra-mode and the inter-mode. The intra-mode is classified into 16×16, 8×8, and 4×4 intra-modes and the inter-mode is classified into 16×16, 16×8, 8×16, and 8×8 inter-modes depending on the size of a prediction block. The 8×8 inter-mode is classified into 8×8, 8×4, 4×8, and 4×4 sub-inter-modes.

The coding of a difference block is performed in order of transform, quantization, and entropy coding. First, in a block coded in a 16×16 intra-mode, transform coefficients are generated by performing transform on a difference block, only DC coefficients are collected from the outputted transform coefficients, and Hadamard-converted DC coefficients are generated by performing Hadamard transform on the DC coefficients.

In a block coded in other coding modes except the 16×16 intra-mode, in a transform process, a difference block is received, and transform coefficients are generated by performing transform on the difference block. Furthermore, in a quantization process, quantized coefficients are outputted by performing quantization on the received transform coefficients using a quantization parameter.

Furthermore, in an entropy coding process, a bit stream is outputted by performing entropy coding according to a probability distribution on the received quantized coefficients.

In H.264, it is necessary to decode a coded picture and store the decoded picture in order to use the stored picture as a reference picture for a received image because inter-frame prediction coding is performed. Accordingly, a dequantized process and inverse transform are performed on the quantized coefficients, a reconstructed block is generated by adding the dequantized and inversely transformed coefficients and a prediction picture through an adder, a blocking artifact generated in the coding process is removed from the reconstructed block through a deblocking filter, and the resulting block is stored in the reference picture buffer.

FIG. 4 is a diagram showing an example of an H.264 decoding structure.

Referring to FIG. 4, a unit on which data is processed in the H.264 decoding structure is a macro block of 16×16 pixels in width and height. A bit stream is received and decoded in an intra-mode or an inter-mode, thereby outputting a reconstructed image.

In the intra-mode, a switch switches to the intra-mode. In the inter-mode, the switch switches to the inter-mode.

A major flow of a decoding process is to generate a prediction block and then generate a reconstructed block by adding a block, that is, a decoding result of a received bit stream, and the prediction block.

First, the generation of the prediction block is performed in the intra-mode and the inter-mode.

In the intra-mode, in an intra-prediction process, the prediction block is generated by performing spatial prediction using values of already coded pixels that neighbor a current block. In the inter-mode, a region is searched for in a reference picture stored in a reference picture buffer using a motion vector, and the prediction block is generated by performing motion compensation on the retrieved region.

In an entropy decoding process, quantized coefficients are generated by performing entropy decoding according to a probability distribution on a received bit stream. A dequantization process and inverse transform are performed on the quantized coefficients, a reconstructed block is generated by adding the dequantized and inversely transformed coefficients and a prediction picture through an adder, a blocking artifact is removed from the reconstructed block through a deblocking filter, and the resulting block is stored in the reference picture buffer.

As an example of another method of coding a depth information map, High Efficiency Video Coding (HEVC) that is being standardized can be used. In this standard, Moving Picture Experts Group (MPEG) and Video Coding Experts Group (VCEG) are jointly standardizing High Efficiency Video Coding (HEVC) that is the next-generation video codec. The MPEG and VCEG have the object to code an image, including a UHD image, with compression efficiency twice than that of H.264/AVC. In this case, video having a lower frequency and high picture quality can be provided even in 3-D broadcasting and mobile communication networks as well as HD and UHD images.

### DISCLOSURE

### Technical Problem

An object of the present invention is to provide a method of determining boundary filtering strength bS at a boundary that neighbors a block to which an intra-frame skip coding mode has been applied as 0 in determining boundary filtering strength when using a deblocking filter, from among in-loop filtering methods, and an apparatus using the method.

Another object of the present invention is to reduce complexity in video coding and decoding and also improve the picture quality of a virtual image generated through a sub-decoded depth image.

Yet another object of the present invention is to provide a video coding method, sampling method, and filtering method for a depth information map.

### Technical Solution

In accordance with an aspect of the present invention, a video decoding method may include generating a prediction pixel value of a neighboring block neighboring a current block as a pixel value of the current block when performing intra-frame prediction on a depth information map.

The video decoding method may further include demultiplexing information about a coded difference picture, information about whether or not the coded difference picture has been decoded, and selection information about a method of generating a prediction block picture; decoding information about whether the current block has been decoded or not in a received bit stream; decoding information about a difference picture for the current block and information about the generation of a prediction block based on the information about whether or not the coded difference picture has been decoded; selecting an intra-frame prediction method or an inter-frame prediction method based on the information about the method of generating a prediction block picture; inferring a prediction direction for the current block from the neighboring block in order to configure a prediction picture; and configuring the prediction picture for a current block picture in the inferred prediction direction.

Configuring the prediction picture for the current block picture may be performed using at least one of a method of configuring an intra-frame prediction picture by copying or padding neighboring pixels neighboring the current block, a method of determining pixels to be copied by taking characteristics of neighboring pixels neighboring the current block into consideration and configuring the current block using the determined pixels, and a method of mixing a plurality of prediction methods and configuring a prediction block picture using an average value of values of the mixed prediction methods or a sum of weight according to each of the prediction methods.

In accordance with another aspect of the present invention, a video decoding method for depth information may include generating the prediction block of a current block for the depth information; generating the restored block of the current block based on the prediction block; and performing filtering on the restored block, wherein whether or not to perform the filtering is determined based on block information about the current block and coding information about the current block.

The coding information may include information about a part having an identical depth, a part being a background, and a part corresponding to the inside of an object within the restored picture, and the filtering may not be performed on at least one of the part having the same depth, the part being the background, and the part corresponding to the part corresponding to the inside of the object within the restored block.

At least one of a deblocking filter, a Sample Adaptive Offset (SAO) filter, an Adaptive Loop Filter (ALF), and In-loop Joint inter-View Depth Filtering (JVDF) may not be performed on at least one of the part having the same depth, the part being the background, and the part corresponding to the part corresponding to the inside of the object within the restored block.

The coding information may include information about a part having an identical depth, a part being a background, and a part corresponding to the inside of an object within the restored picture, and weak filtering may be performed on at least one of the part having the same depth, the part being the background, and the part corresponding to the part corresponding to the inside of the object within the restored block.

The video decoding method may further include performing up-sampling on the restored block, and the up-sampling may include padding one sample value with a predetermined number of sample values.

The up-sampling may not be performed in at least one of the part having the same depth, the part being the background, and the part corresponding to the inside of the object within the restored block.

Performing filtering on the restored block may include determining boundary filtering strength for two neighboring blocks and applying the filtering to pixel values of the two neighboring blocks based on the boundary filtering strength. Determining the boundary filtering strength may include determining whether or not at least one of the two neighboring blocks has been intra-skip coded; determining whether or not at least one of the two neighboring blocks has been intra-coded if, as a result of the determination, it is determined that both the two neighboring blocks have not been intra-skip coded; determining whether or not at least one of the two neighboring blocks has an orthogonal transform coefficient if, as a result of the determination, it is determined that both the two neighboring blocks have not been intra-coded; determining whether or not at least one of absolute values of a difference between x-axis components or y-axis components of a motion vector is 1 or 4 or higher or whether or not motion compensation has been performed based on different reference frames if, as a result of the determination, it is determined that both the two neighboring blocks do not have any orthogonal transform coefficient; and determining whether or not all the absolute values of the difference between the x-axis components or the y-axis components of the motion vector is smaller than 1 or 4 and whether or not the motion compensation has been performed based on an identical reference frame.

The boundary filtering strength may be determined as 0 if, as a result of the determination, it is determined that at least one of the two neighboring blocks has been intra-skip coded.

The boundary filtering strength may be determined as any one of 1, 2, 3, and 4 if it is determined that one of the two neighboring blocks is in an intra-skip coding mode, the other of the two neighboring blocks is in a common intra-mode or inter-mode, and at least one orthogonal transform coefficient is present in the common intra-mode or inter-mode.

The boundary filtering strength may be determined as any one of 0, 1, 2, and 3 if it is determined that both the two neighboring blocks are in a common intra-mode or inter-mode and any orthogonal transform coefficient is not present in the common coding mode.

If a prediction mode of the current block is an intra-skip mode not having difference information, generating the prediction block of the current block may include inferring a prediction direction for the current block from neighboring blocks that neighbor the current block.

Performing filtering on the restored block may include determining boundary filtering strength for two neighboring blocks and applying the filtering to pixel values of the two neighboring blocks based on the boundary filtering strength. Determining the boundary filtering strength may include determining the boundary filtering strength as 0 if a prediction direction for the current block is identical with a prediction direction of a neighboring block that neighbors the current block.

Performing filtering on the restored block may include determining boundary filtering strength for two neighboring blocks and applying the filtering to pixel values of the two neighboring blocks based on the boundary filtering strength. Determining the boundary filtering strength may include setting the boundary filtering strength for a vertical boundary of the current block to 0 if a prediction mode of the current block is an intra-skip mode not having difference information and an intra-frame prediction direction for the current block is a horizontal direction and setting the boundary filtering strength for a horizontal boundary of the current block to 0 if a prediction mode of the current block is an intra-skip mode not having difference information and an intra-frame prediction direction for the current block is a vertical direction.

Performing filtering on the restored block may include determining boundary filtering strength for two neighboring blocks and applying the filtering to pixel values of the two neighboring blocks based on the boundary filtering strength. Determining the boundary filtering strength may include setting the boundary filtering strength to 0 if boundaries of the current block and a neighboring block that neighbors the current block are identical with a boundary of a macro block.

In accordance with yet another aspect of the present invention, a video decoding apparatus for depth information may include a prediction picture generation module for generating the prediction block of a current block for the depth information; an addition module for generating the restored block of the current block based on the prediction block; and a filter module for performing filtering on the restored block, wherein the filter module may include a boundary filtering strength determination module for determining boundary filtering strength for two neighboring blocks and a filtering application module for applying filtering to pixel values of the two neighboring blocks based on the boundary filtering strength.

The boundary filtering strength determination module may determine the boundary filtering strength as 0 if at least one of the two neighboring blocks has been intra-skip coded.

The boundary filtering strength determination module may determine the boundary filtering strength as any one of 1, 2, 3, and 4 if one of the two neighboring blocks is in an intra-skip coding mode, the other of the two neighboring blocks is in a common intra-mode or inter-mode, and at least one orthogonal transform coefficient is present in the common intra-mode or inter-mode.

### Advantageous Effects

In accordance with an embodiment of the present invention, a method of determining boundary filtering strength bS at a boundary that neighbors a block to which an intra-frame skip coding mode has been applied as 0 in determining boundary filtering strength when using a deblocking filter, from among in-loop filtering methods, and an apparatus using the method are provided.

In accordance with another technical embodiment of the present invention, complexity can be reduced in video coding and decoding, and the picture quality of a virtual image generated through a sub-decoded depth image can be improved.

In accordance with yet another technical embodiment of the present invention, a video coding method, sampling method, and filtering method for a depth information map are provided.

### DESCRIPTION OF DRAWINGS

FIG. 1 is a diagram showing a basic structure and data format of a 3-D video system;

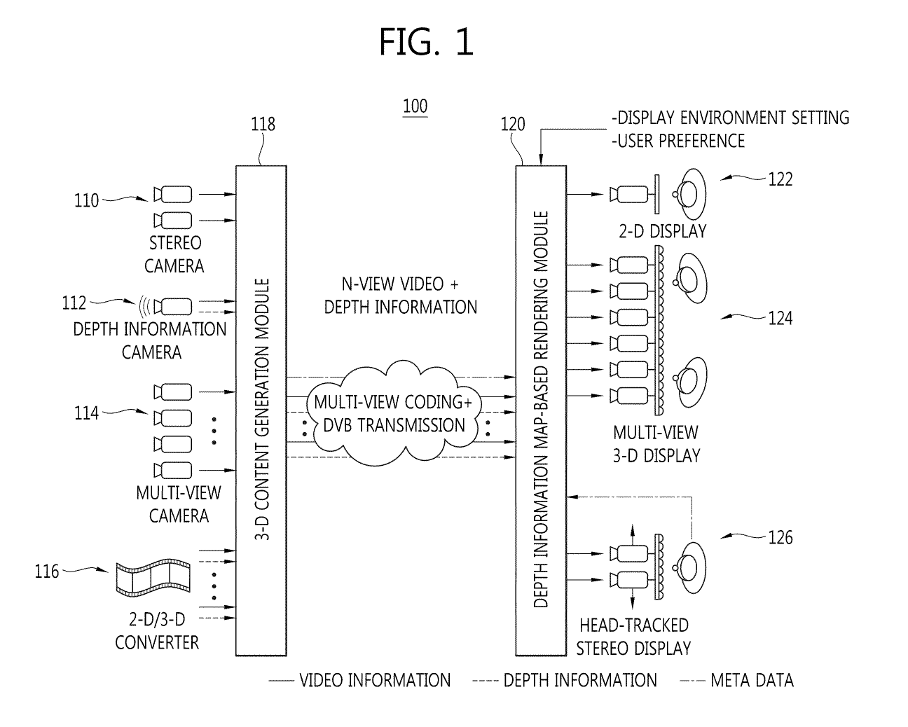

FIG. 2 is a diagram showing a depth information map for an image ‘balloons’;

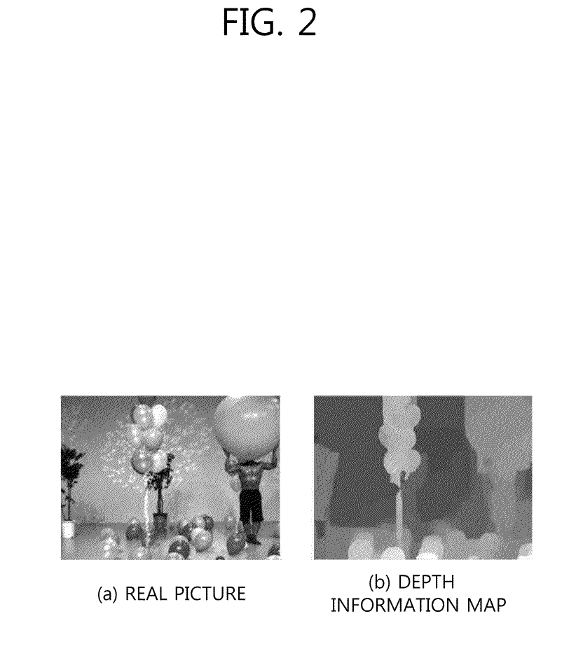

FIG. 3 is a diagram showing an example of an H.264 coding structure;

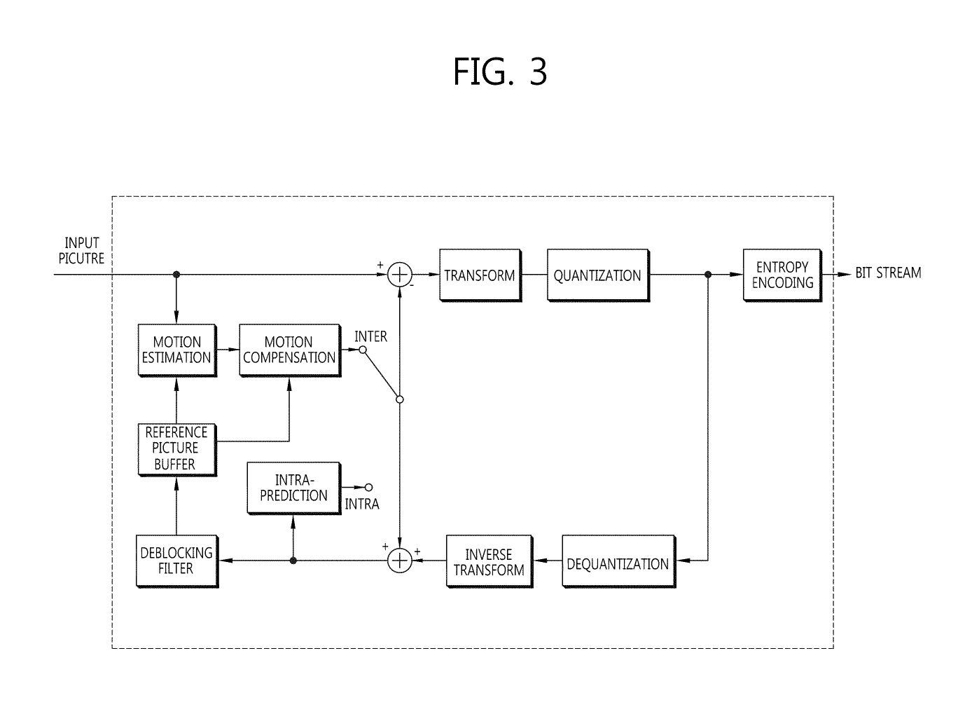

FIG. 4 is a diagram showing an example of an H.264 decoding structure;

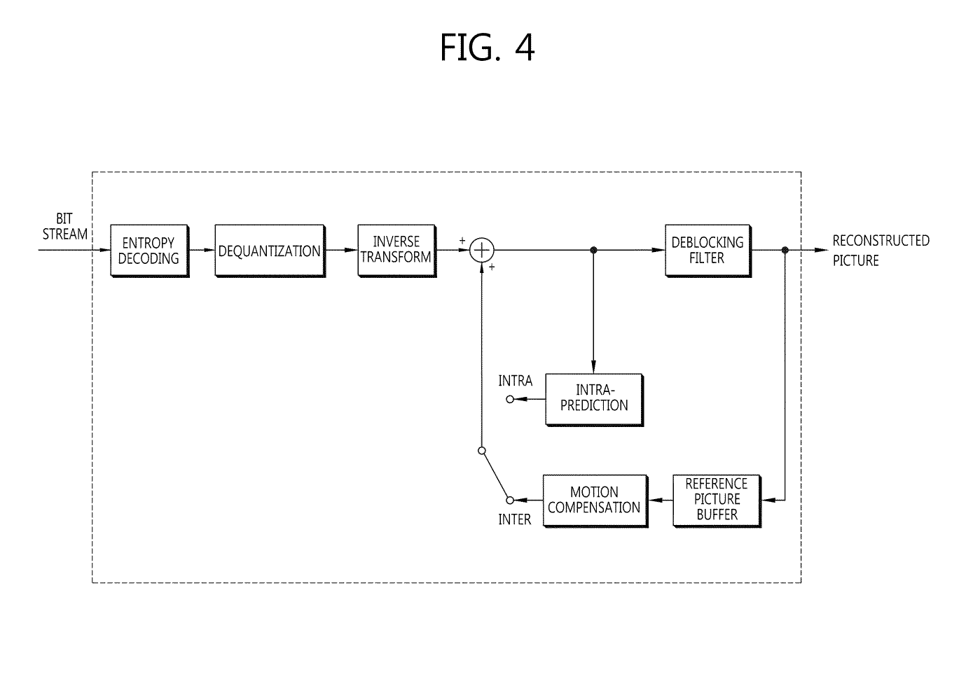

FIG. 5 is a control block diagram showing the construction of a video coding apparatus in accordance with an embodiment of the present invention;

FIG. 6 is a control block diagram showing the construction of a video decoding apparatus in accordance with an embodiment of the present invention;

FIG. 7a is a diagram showing a depth information map for an image ‘kendo’;

FIG. 7b is a 2-D graph showing values of pixels in a horizontal direction in specific locations of the depth information map for the image ‘kendo’;

FIG. 7c is a 2-D graph showing values of pixels in a vertical direction in specific locations of the depth information map for the image ‘kendo’;

FIG. 8 is a diagram illustrating a plane-based partition intra-frame prediction method;

FIG. 9 is a diagram showing neighboring blocks used to infer a prediction direction for a current block in accordance with an embodiment of the present invention;

FIG. 10 is a control flowchart illustrating a method of deriving an intra-frame prediction direction for a current block in accordance with an embodiment of the present invention;

FIG. 11 is a control flowchart illustrating a method of deriving an intra-frame prediction direction for a current block in accordance with another embodiment of the present invention;

FIG. 12 is a diagram showing neighboring blocks used to infer a prediction direction for a current block in accordance with another embodiment of the present invention;

FIG. 13 is a diagram showing an example of a method of down-sampling a depth information map;

FIG. 14 is a diagram showing an example of a method of up-sampling a depth information map;

FIG. 15 is a control flowchart illustrating a method of determining boundary filtering strength bS of deblocking filtering in accordance with an embodiment of the present invention;

FIG. 16 is a diagram showing the boundary of a neighboring block ‘p’ and a block ‘q’;

FIG. 17 is a control flowchart illustrating a method of determining boundary filtering strength bS of deblocking filtering in accordance with another embodiment of the present invention;

FIG. 18 is a diagram showing the prediction directions and macro block boundaries of a current block and a neighboring block in accordance with an embodiment of the present invention;

FIG. 19 is a diagram showing a coding mode of a current block and the boundaries of the current block;

FIG. 20 is a control block diagram showing the construction of a video coding apparatus in accordance with an embodiment of the present invention; and

FIG. 21 is a control block diagram showing the construction of a video decoding apparatus in accordance with an embodiment of the present invention.

### MODE FOR INVENTION

Some exemplary embodiments of the present invention are described in detail with reference to the accompanying drawings. Furthermore, in describing the embodiments of this specification, a detailed description of the known functions and constitutions will be omitted if it is deemed to make the gist of the present invention unnecessarily vague.

In this specification, when it is said that one element is ‘connected’ or ‘coupled’ with the other element, it may mean that the one element may be directly connected or coupled with the other element or a third element may be ‘connected’ or ‘coupled’ between the two elements. Furthermore, in this specification, when it is said that a specific element is ‘included’, it may mean that elements other than the specific element are not excluded and that additional elements may be included in the embodiments of the present invention or the scope of the technical spirit of the present invention.

Terms, such as the first and the second, may be used to describe various elements, but the elements are not restricted by the terms. The terms are used to only distinguish one element from the other element. For example, a first element may be named a second element without departing from the scope of the present invention. Likewise, a second element may be named a first element.

Furthermore, element modules described in the embodiments of the present invention are independently shown to indicate difference and characteristic functions, and it does not mean that each of the element modules is formed of a piece of separate hardware or a piece of software. That is, the element modules are arranged and included, for convenience of description, and at least two of the element modules may form one element module or one element may be divided into a plurality of element modules and the plurality of divided element modules may perform functions. An embodiment into which the elements are integrated or embodiments from which some elements are separated are also included in the scope of the present invention, unless they depart from the essence of the present invention.

Furthermore, in the present invention, some elements are not essential elements for performing essential functions, but may be optional elements for improving only performance. The present invention may be implemented using only essential elements for implementing the essence of the present invention other than elements used to improve only performance, and a structure including only essential elements other than optional elements used to improve only performance is included in the scope of the present invention.

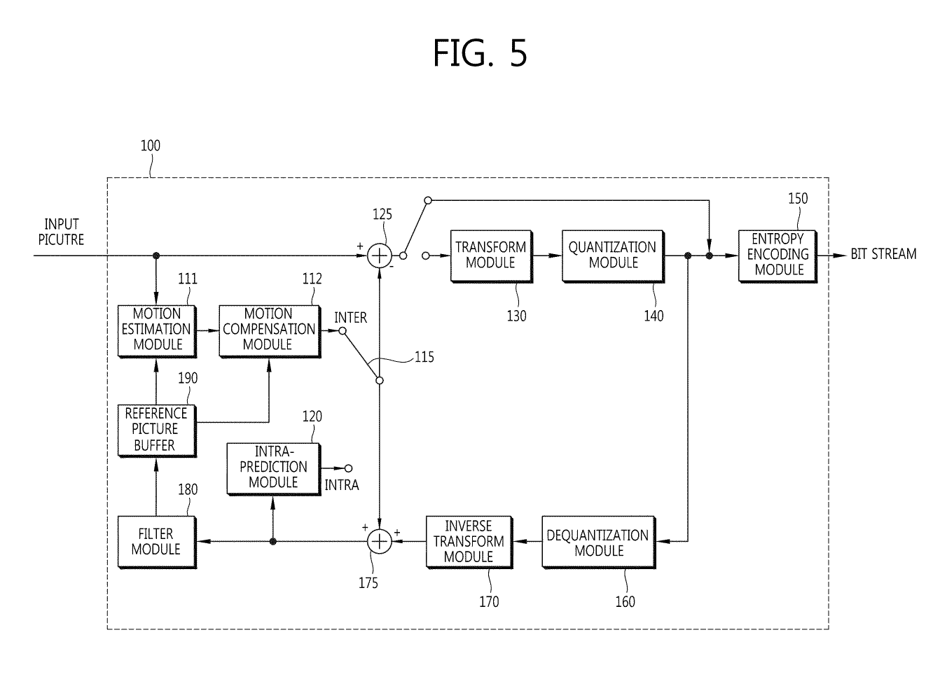

FIG. 5 is a block diagram of a construction in accordance with an embodiment of a video coding apparatus. A scalable video coding/decoding method or apparatus can be implemented by extending a common video coding/decoding method or apparatus that do not provide scalability. The block diagram of FIG. 5 illustrates an embodiment of a video coding apparatus that may become a basis for the scalable video coding apparatus.

Referring to FIG. 5, the video coding apparatus 100 includes a motion estimation module 111, a motion compensation module 112, an intra-prediction module 120, a switch 115, a subtractor 125, a transform module 130, a quantization module 140, an entropy coding module 150, a dequantization module 160, an inverse transform module 170, an adder 175, a filter module 180, and a reference picture buffer 190.

The video coding apparatus 100 can perform coding on an input picture in an intra-mode or an inter-mode and output a bit stream. In this specification, intra-prediction means intra-frame prediction, and inter-prediction means inter-frame prediction. In the intra-mode, the switch 115 can switch to intra mode. In the inter-mode, the switch 115 can switch to the inter-mode. The video coding apparatus 100 can generate a prediction block for the input block of an input picture and then encode a difference between the input block and the prediction block.

Here, whether or not to code a block for the generated difference can be determined based on better coding efficiency from a rate-distortion viewpoint. The prediction block can be generated through an intra-frame prediction process or an inter-frame prediction process. Furthermore, whether the intra-frame prediction process or the inter-frame prediction process will be performed can be determined based on better coding efficiency from a rate-distortion viewpoint.

In the intra-mode, the intra-prediction module 120 can generate the prediction block by performing spatial prediction based on values of the pixels of already coded blocks that neighbor a current block.

In the inter-mode, the motion estimation module 111 can obtain a motion vector by searching a reference picture, stored in the reference picture buffer 190, for a region that is most well matched with the input block in a motion estimation process. The motion compensation module 112 can generate the prediction block by performing motion compensation based on the motion vector and the reference picture stored in the reference picture buffer 190.

The subtractor 125 can generate a difference block based on the residual between the input block and the generated prediction block. The transform module 130 can perform transform on the difference block and output a transform coefficient according to the transformed block. Furthermore, the quantization module 140 can output a quantized coefficient by quantizing the received transform coefficient based on at least one of a quantization parameter and a quantization matrix.

The entropy coding module 150 can perform entropy coding on a symbol according to a probability distribution based on values calculated by the quantization module 140 or coding parameter values calculated in a coding process and output a bit stream. The entropy coding method is a method of receiving a symbol having various values and representing the symbol in the form of a string of a binary number that can be decoded while removing statistical redundancy.

Here, a symbol means a target coding/decoding syntax element, a coding parameter, or a value of a residual signal. The coding parameter is a parameter necessary for coding and decoding. The coding parameter can include information, such as a syntax element that is coded by a coder and then transferred to a decoder, and information that can be inferred in a coding or decoding process. The coding parameter means information that is necessary to code or decode video. The coding parameter can include, for example, an intra/inter-prediction mode, a moving/motion vector, a reference picture index, a coding block pattern, the existence or non-existence of a residual signal, a transform coefficient, a quantized transform coefficient, a quantization parameter, a block size, and a value or statistics, such as block partition information. Furthermore, the residual signal can mean a difference between the original signal and a prediction signal. Furthermore, the residual signal may mean a signal having a form in which a difference between the original signal and a prediction signal is transformed or a signal having a form in which a difference between the original signal and a prediction signal is transformed and quantized. The residual signal can also be called a difference block in a block unit.

If entropy coding is used, the size of a bit stream for a symbol to be coded can be reduced because the symbol is represented by allocating a small number of bits to a symbol having a high incidence and a large number of bits to a symbol having a low incidence. Accordingly, compression performance for video coding can be improved through entropy coding.

For the entropy coding, coding methods, such as exponential Golomb, Context-Adaptive Binary Arithmetic Coding (CABAC), and Context-Adaptive Binary Arithmetic Coding (CABAC), can be used. For example, the entropy coding module 150 can store a table for performing entropy coding, such as a Variable Length Coding/Code (VLC) table. The entropy coding module 150 can perform entropy coding using the stored VLC table. Furthermore, the entropy coding module 150 may derive a method of binarizing a target symbol and a probability model for a target symbol/bin and perform entropy coding using the derived binarization method or probability model.

The quantized coefficient is dequantized by the dequantization module 160 and then inversely transformed by the inverse transform module 170. The dequantized and inversely transformed coefficient is added to the prediction block through the adder 175, thereby generating a restored block.

The restored block experiences the filter module 180. The filter module 180 can apply one or more of a deblocking filter, a Sample Adaptive Offset (SAO), and an Adaptive Loop Filter (ALF) to the restored block or the restored picture. The restored block passing through the filter module 180 can be stored in the reference picture buffer 190.

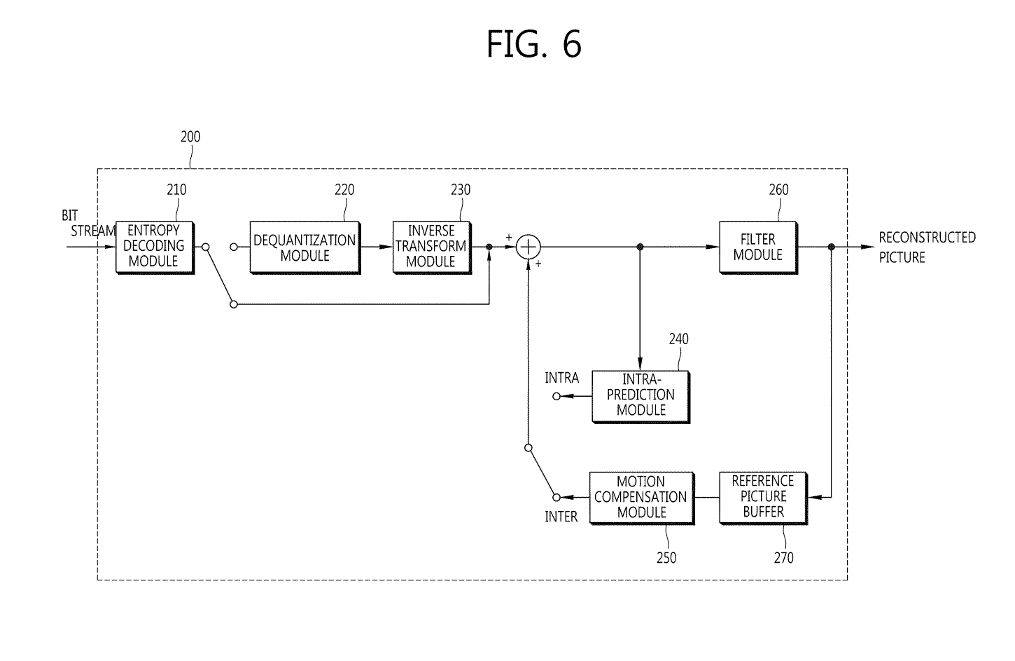

FIG. 6 is a block diagram of a construction in accordance with an embodiment of a video decoding apparatus. As described with reference to FIG. 5, a scalable video coding/decoding method or apparatus can be implemented by extending a common video coding/decoding method or apparatus that do not provide scalability. The block diagram of FIG. 6 illustrates an embodiment of a video decoding apparatus that may become a basis for a scalable video decoding apparatus.

Referring to FIG. 6, the video decoding apparatus 200 includes an entropy decoding module 210, a dequantization module 220, an inverse transform module 230, an intra-prediction module 240, a motion compensation module 250, a filter module 260, and a reference picture buffer 270.

The video decoding apparatus 200 can receive a bit stream outputted from the coder, perform decoding on the bit stream in the intra-mode or the inter-mode, and output a restored picture, that is, a restored picture. In the intra-mode, a switch can switch to intra-mode. In the inter-mode, the switch can switch to the inter-mode. The video decoding apparatus 200 can obtain a restored difference block from the received bit stream, generate a prediction block, and then generate a reconstructed block, that is, a restored block, by adding the restored difference block to the prediction block.

The entropy decoding module 210 can generate symbols including a symbol having a quantized coefficient form by performing entropy decoding on the received bit stream according to a probability distribution. The entropy decoding method is a method of receiving a string of a binary number and generating symbols. The entropy decoding method is similar to the aforementioned entropy coding method.

The quantized coefficient is dequantized by the dequantization module 220 and then inversely transformed by the inverse transform module 230. As a result of the dequantization/inverse transform of the quantized coefficient, a difference block can be generated.

In the intra-mode, the intra-prediction module 240 can generate a prediction block by performing spatial prediction based on pixel values of already decoded blocks neighboring the current block. In the inter-mode, the motion compensation module 250 can generate a prediction block by performing motion compensation based on a motion vector and a reference picture stored in the reference picture buffer 270.

The restored difference block and the prediction block are added together by an adder 255. The added block experiences the filter module 260. The filter module 260 can apply at least one of a deblocking filter, an SAO, and an ALF to the restored block or the restored picture. The filter module 260 outputs a restored picture, that is, a restored picture. The restored picture can be stored in the reference picture buffer 270 and can be used for inter-frame prediction.

Meanwhile, a depth information map used to generate virtual view video has a high correlation between pixels because it indicates a distance between a camera and the object. In particular, values having the same depth information widely appear in the inside of the object or a background part.

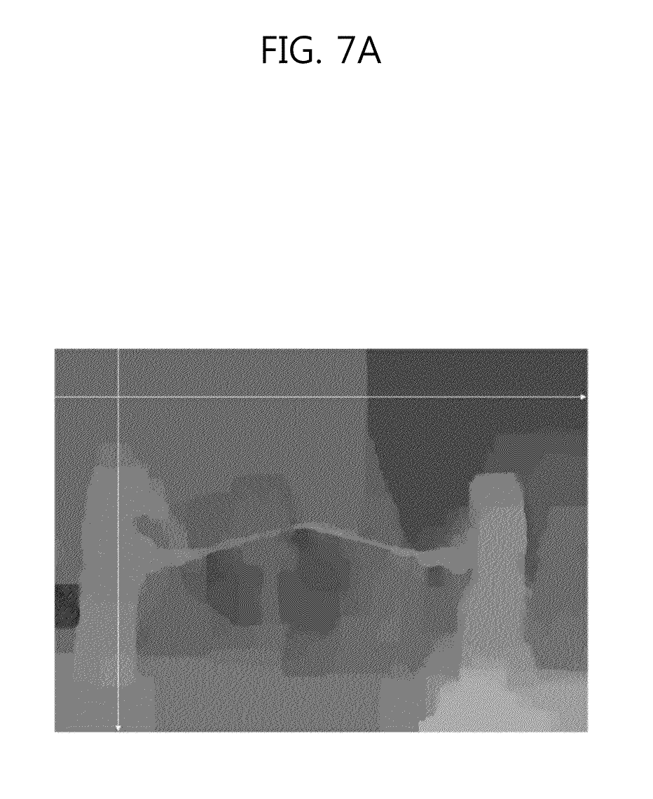

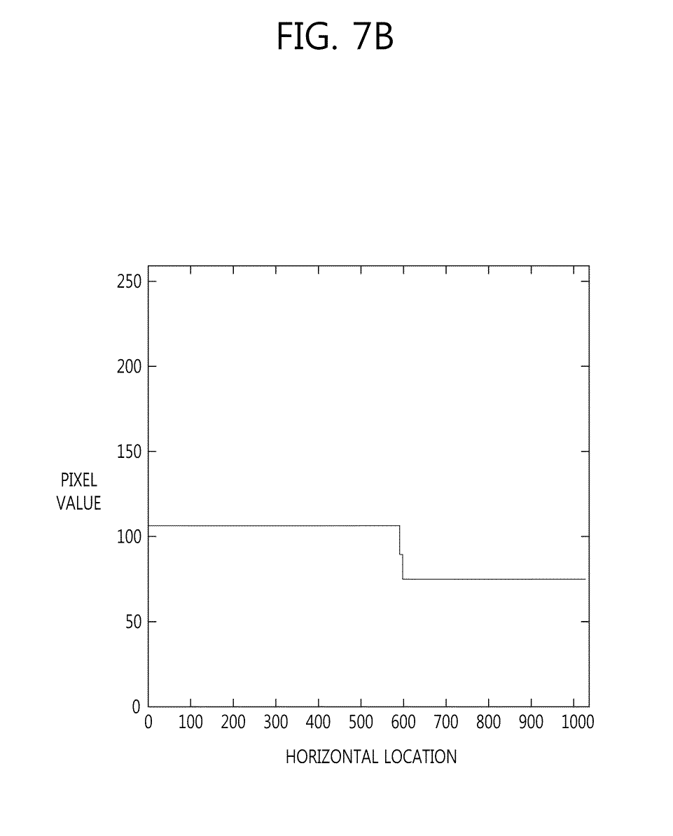

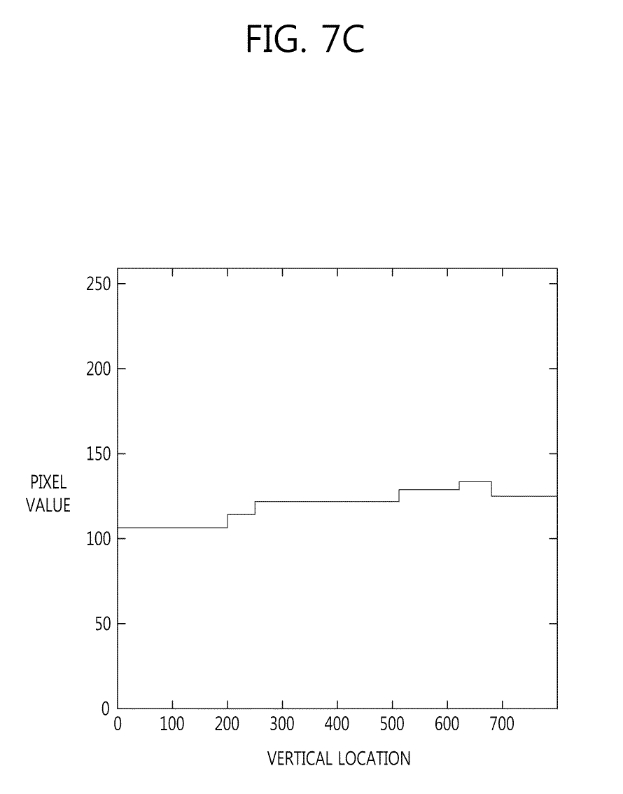

FIG. 7a is a diagram showing a depth information map for an image ‘kendo’, FIG. 7b is a 2-D graph showing values of pixels in a horizontal direction in specific locations of the depth information map for the image ‘kendo’, and FIG. 7c is a 2-D graph showing values of pixels in a vertical direction in specific locations of the depth information map for the image ‘kendo’.

From FIGS. 7a to 7c, it can be seen that the pixels of the depth information map have a very high correlation. In particular, it can be seen that depth information has the same value in the inside of the object and a background part in the depth information map.

FIG. 7b shows pixel values of a part corresponding to the horizontal line II-II of FIG. 7a. As shown in FIG. 7b, the part corresponding to the horizontal line II-II of FIG. 7a is divided into two regions. From FIG. 7b, it can be seen that depth information values within the two regions are the same if the two regions have only to be incorporated into the depth values.

FIG. 7c shows pixel values of a part corresponding to the vertical line III-III of FIG. 7a. As shown in FIG. 7c, the part corresponding to the vertical line III-III of FIG. 7b are divided into two regions. From FIG. 7c, it can be seen that depth information values within the two regions are the same if the two regions have only to be incorporated into the depth values.

When performing intra-frame prediction in an image having a high correlation between pixels, coding and decoding processes for a residual signal, that is, a difference value between a current block and a prediction block, are rarely necessary because pixel values of the current block are rarely predicted using only pixel values of neighboring blocks.

In this case, as shown in FIGS. 5 and 6, transform and quantization processes and dequantization and inverse transform processes for the residual signal are not necessary.

Accordingly, calculation complexity can be reduced and coding efficiency can be improved through intra-frame coding using the above characteristics. Furthermore, if all depth values are the same as in a background part or the inside of the object, calculation complexity can be reduced by not performing processes, such as filtering (e.g., a deblocking filter, a Sample Adaptive Offset (SAO) filter, and an Adaptive Loop Filter (ALF)), on a corresponding part.

The boundary part of the object in a depth information map is an element that is very important for a virtual image composition. A method of coding the boundary part of the object in the depth information map includes a plane-based partition intra-frame prediction method, for example.

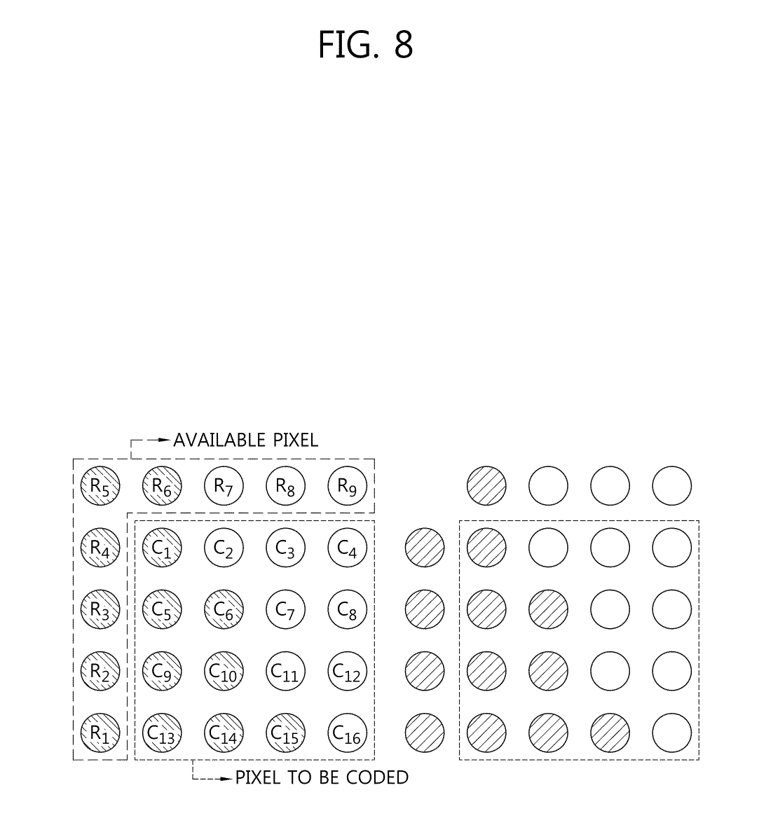

FIG. 8 is a diagram illustrating the plane-based partition intra-frame prediction method.

As shown in Error! Reference source not found., the plane-based partition intra-frame prediction method is a method of dividing a current block into two regions (i.e., the inside of the object and the outside of the object) on the basis of pixels neighboring the current block and performing coding. Here, divided binary bitmap information is transmitted to a decoder.

The plane-based partition intra-frame prediction method is applied to the boundary part of the object in a depth information map. If a depth information map is used while maintaining the characteristics of the boundary part of the object as in the method, that is, without smoothing or crushing the boundary of the object, a virtual composition image can have improved picture quality. Accordingly, filtering that crushes the boundary of the object, such as a defiltering process, may not be performed on the boundary part of the object in the depth information map.

An existing deblocking filtering method is for removing a blocking artifact in a block boundary part which results from a coding mode (i.e., intra-frame prediction mode or inter-frame prediction mode) between two neighboring blocks, the identity of a reference picture between the two neighboring blocks, and a difference in motion information between the two neighboring blocks. Accordingly, the strength of deblocking when performing a deblocking filter on the block boundary part is determined based on a coding mode (i.e., intra-frame prediction mode or inter-frame prediction mode) between the two neighboring blocks, the identity of a reference picture between the two neighboring blocks, and a difference in motion information between the two neighboring blocks. For example, if one of two neighboring blocks has been subjected to intra-frame prediction and the other thereof has been coded in an inter-frame prediction mode, a very severe blocking artifact can be generated between the two neighboring blocks. In this case, a deblocking filter can be performed with high strength.

For another example, if both two neighboring blocks have been subjected to inter-frame prediction, the two neighboring blocks have the same reference picture, and the two neighboring blocks have the same motion information, a blocking artifact may not be generated between the two neighboring blocks. In this case, a deblocking filter may not be performed or may be performed weakly.

This deblocking filter functions to improve the subjective picture quality of an image by removing a blocking artifact from the image. However, a depth information map is used to generate a virtual composition image, but is not actually outputted to a display device. Accordingly, a block boundary of this depth information map may be necessary to improve the picture quality of a virtual composition image not to improve the subjective picture quality.

Furthermore, in a deblocking filter (or other filtering methods) for a depth information map, it is necessary to determine whether filtering has been performed or not and set filtering strength based on a coding mode of a current block, not based on a coding mode (i.e., intra-frame prediction mode or inter-frame prediction mode) between two neighboring blocks, the identity of a reference picture between the two neighboring blocks, and a difference in motion information between the two neighboring blocks.

For example, if a current block has been coded according to the plane-based partition coding method for coding the boundary part of the object, it may be more effective not to perform a deblocking filter on a block boundary so that the boundary part of the object is not crushed to the highest degree.

Hereinafter, there is proposed a method of reducing calculation complexity and improving coding efficiency when performing intra-frame coding on an image having a high correlation between pixels. A depth information map is depth information indicative of a distance between the objects. In general, a depth information map has a very gentle value.

In particular, depth information in a background part or the inside of the object has the same value widely. Depth information about a current block can be configured by padding depth values of neighboring blocks on the basis of this characteristic.

Furthermore, a filtering process that is applied to a common image may not be performed on parts having the same depth value widely. Furthermore, a simple sampling (i.e., up-sampling or down-sampling) process can be applied. The present invention proposes an intra-frame coding method for various depth information maps and methods for filtering and sampling depth information maps.

Intra-Frame Coding Method for Depth Information Map

In general, when predicting a prediction block using the intra-frame prediction method, the prediction block is predicted through blocks that neighbor an already coded current block. A method of configuring a current block using only an intra-frame prediction block as described above is called an intra-prediction mode.

In the present invention, a block coded in the intra-prediction mode is called an intra 16×16 mode (or 8×8 mode, 4×4 mode, or N×N mode) and also called an intra-skip mode when difference data is not present. A block coded in the intra-skip mode is advantageous in that an intra-frame prediction direction for a corresponding block can be inferred from neighboring blocks already spatially coded. In other words, in the block coded in the intra-skip mode, information about an intra-frame prediction direction and other pieces of information are not transmitted to a decoding apparatus, and information about an intra-frame prediction direction for a current block can be derived from only information about neighboring blocks.

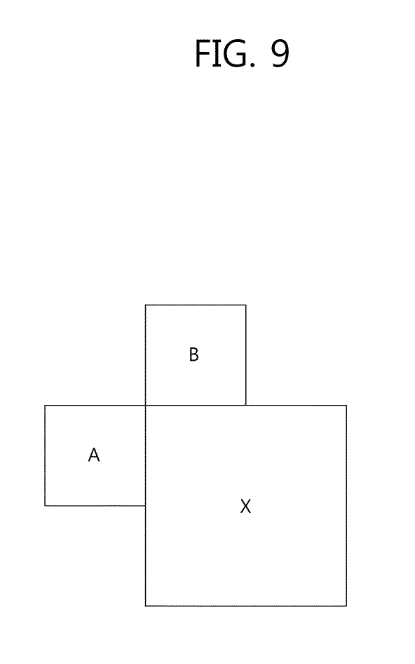

FIG. 9 is a diagram showing neighboring blocks used to infer a prediction direction for a current block in accordance with an embodiment of the present invention.

Referring FIG. 9, an intra-frame prediction direction for a current block X can be inferred from neighboring blocks A and B that neighbor the current block X. Here, the neighboring blocks can mean all blocks neighboring the current block X. A method of deriving the intra-frame prediction direction for the current block X can be various, and one embodiment of the methods is described in detail below.

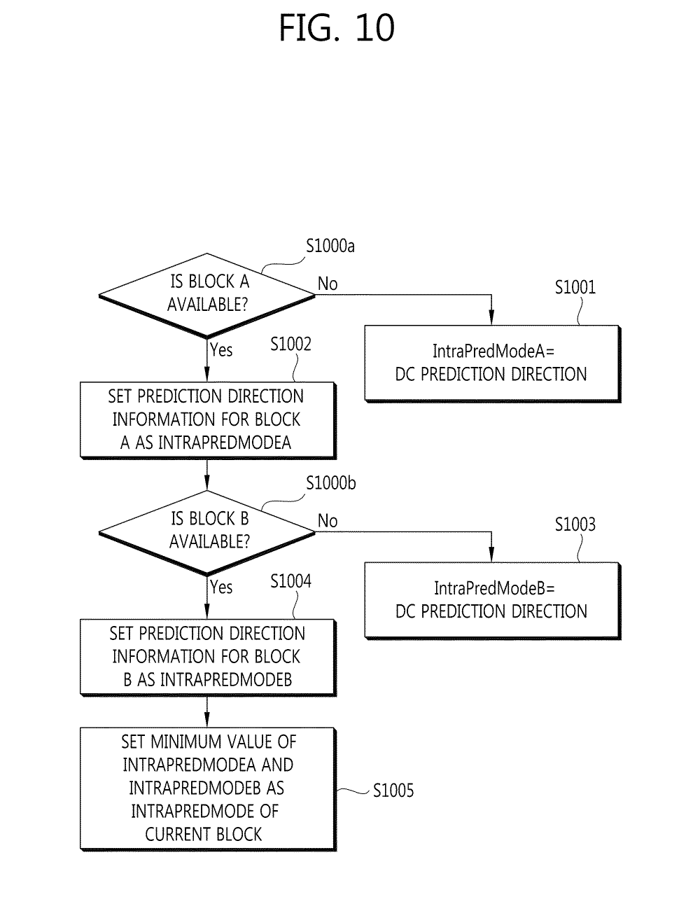

FIG. 10 is a control flowchart illustrating a method of deriving an intra-frame prediction direction for a current block in accordance with an embodiment of the present invention.

First, it is assumed that vertical prediction (0), horizontal prediction (1), DC prediction (2) using a specific average value, and plane (or diagonal line) prediction (3) are present in an intra-frame prediction direction. A value for a prediction direction becomes smaller according to a higher probability of occurrence. For example, vertical prediction (0) has the highest probability of occurrence. In addition to the above predictions, lost of prediction directions can be present, and a prediction direction has a different probability of occurrence depending on the size of a block. Information about a prediction direction for a current block can be indicated by ‘IntraPredMode’.

First step) the availability of a block A is determined at step S1000a. If, as a result of the determination, it is determined that the block A is unavailable, for example, the block A has not been coded or a coding mode of the block A cannot be used, IntraPredModeA (i.e., information about a prediction direction for the block A) is set in a DC prediction direction at step S1001.

In contrast, if, as a result of the determination, it is determined that the block A is available, a second step is performed.

Second step) if the block A is an intra 16×16 coding mode (or 8×8 coding mode or 4×4 coding mode) or an intra-skip coding mode, IntraPredMode for the block A, that is, information about a prediction direction for the block A, is set as IntraPredModeA at step S1002.

Third step) if a block B has not been coded or it is determined that the block B is unavailable, such as a case where a coding mode of the block B cannot be used, at step S1000b, IntraPredModeB (i.e., information about a prediction direction for the block B) is set in a DC prediction direction at step S1003. If not, a fourth step is performed.

Fourth step) if the block B is an intra 16×16 coding mode (or 8×8 coding mode or 4×4 coding mode) or an intra-skip coding mode, IntraPredMode for the block B is set as IntraPredModeB at step S1004.

Fifth step) next, a minimum value of a value of IntraPredModeA and a value of IntraPredModeB can be set as IntraPredMode of a current block X at step S1005.

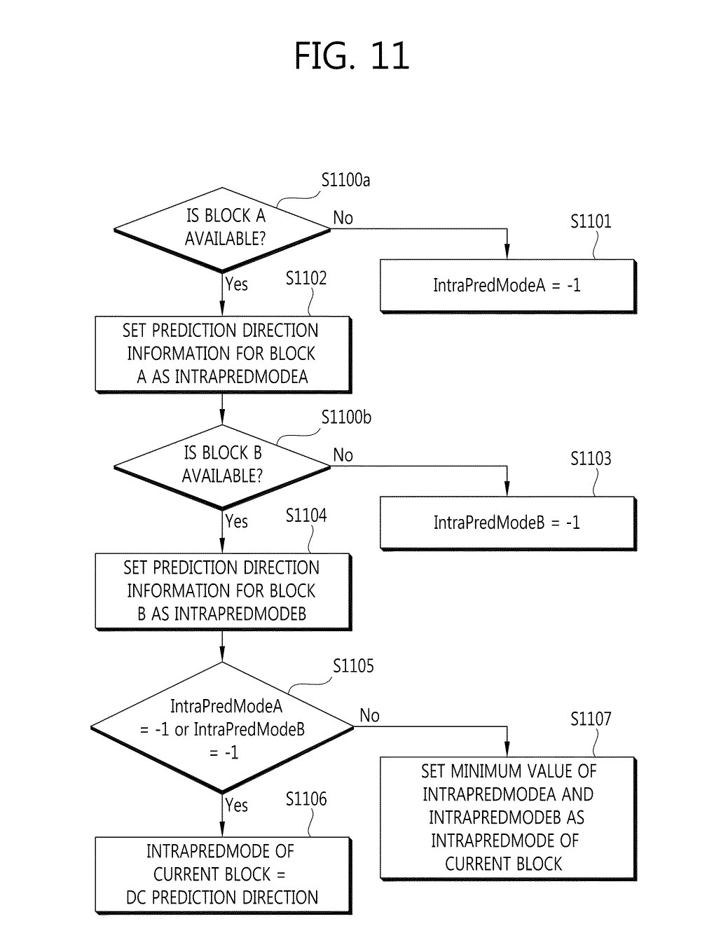

FIG. 11 is a control flowchart illustrating a method of deriving an intra-frame prediction direction for a current block in accordance with another embodiment of the present invention.

First step) if a block A has not been coded or a coding mode of the block A cannot be used, that is, it is determined that the block A is unavailable, at step S1100a, IntraPredModeA is set to ‘−1’ at step S1101.

In contrast, if the block A is available, a second step is performed. Second step) if the block A is an intra 16×16 coding mode (or 8×8 coding mode or 4×4 coding mode) or an intra-skip coding mode, IntraPredMode for the block A, that is, information about a prediction direction for the block A, is set as IntraPredModeA at step S1102.

Furthermore, a step of deriving an intra-frame prediction direction for a block B is performed.

Third step) if the block B has not been coded or a coding mode of the block B cannot be used at step S1100b, IntraPredModeB is set to ‘−1’. If not, a fourth step is performed.

Fourth step) if the block B is an intra 16×16 coding mode (or 8×8 coding mode or 4×4 coding mode) or an intra-skip coding mode, IntraPredMode for the block B is set as IntraPredModeB at step S1104.

Fifth step) next, if it is determined that at least one of IntraPredModeA and IntraPredModeB is ‘−1’ at step S1105, IntraPredMode for a current block X is set in a DC prediction direction at step S1106.

If it is determined that at least one of IntraPredModeA and IntraPredModeB is not ‘−1’, a minimum value of a value of IntraPredModeA and a value of IntraPredModeB is set as IntraPredMode for the current block X at step S1107.

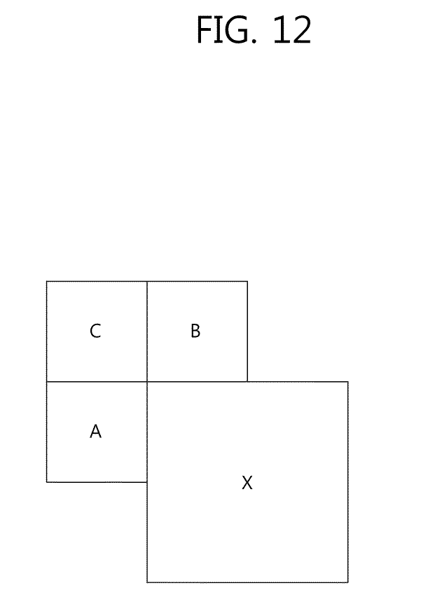

FIG. 12 is a diagram showing neighboring blocks used to infer a prediction direction for a current block in accordance with another embodiment of the present invention.

As shown in FIG. 12, information about a prediction direction for a block C can be used as well as blocks A and B neighboring a current block X. Here, a prediction direction for the current block X can be inferred based on the characteristics of prediction directions for the blocks A, B, and C.

For example, if all the blocks A, B, and C have the same prediction direction, the prediction direction of the block A can be set as a prediction direction for the current block X.

If the blocks A, B, and C have different prediction directions, a minimum value of the prediction directions of the blocks A, B, and C can be set as a prediction direction for the current block X.

Furthermore, if the blocks A and C have the same prediction direction and the blocks B and C have different prediction directions, the prediction direction of the block B can be set as a prediction direction for the current block X.

Alternatively, if the blocks A and C have the same prediction direction and the blocks B and C have different prediction directions, the prediction direction of the block A can be set as a prediction direction for the current block X.

Furthermore, if the blocks B and C have the same prediction direction and the blocks A and C have different prediction directions, the prediction direction of the block A can be set as a prediction direction for the current block X.

Alternatively, if the blocks B and C have the same prediction direction and the blocks A and C have different prediction directions, the prediction direction of the block B can be set as a prediction direction for the current block X.

After determining the prediction direction of the current block, a method of configuring an intra-frame prediction picture can be implemented in various ways.

In one embodiment, a current block can be configured by copying (or padding) values of neighboring blocks to the current block without change. Here, the pixels to be copied (or padded) to the current block can be upper pixels or left pixels in neighboring blocks that neighbor the current block. Furthermore, the pixels can be an average or weighted average of pixels that neighbor the current block.

Furthermore, information regarding that a pixel at what location will be used can be coded and included in a bit stream. This method can be similar to the H.264/AVC intra-frame prediction method.

In another embodiment, pixels to be copied can be determined by taking the characteristics of neighboring pixels that neighbor a current block into consideration, and a current block can be configured using the determined pixels.

More particularly, if a pixel value of a block located at the left top of a current block is identical with or similar to that of a block located on the left of the current block, a prediction block for the current block can be generated using a pixel of a block located at the top of the current block. Furthermore, if a pixel value of a block located at the left top of a current block is identical with or similar to that of a block located on the upper side of the current block, a prediction block for the current block can be generated using a pixel of a left block that neighbors the current block.

In yet another embodiment, several prediction methods can be mixed, and a prediction block picture can be configured using an average value of the several prediction methods or the sum of weights according to the prediction methods.

In addition, a method of configuring an intra-frame prediction block can be changed in various ways as described above.

By inferring an intra-frame prediction direction for a current block from neighboring blocks neighboring the current block as described above, information about the intra-frame prediction direction for the current block is not transmitted to a decoder. In other words, in the case of a block to which an intra-skip mode has been applied, information about an intra-frame prediction direction for the block can be inferred through neighboring blocks or other pieces of information.

In the inter-frame prediction process, a block that is most similar to a current block is fetched from a previous frame that has been coded and decoded, and a prediction block for the current block is generated using the fetched block.

A difference between an image of the generated prediction block and an image of the current block is obtained, thereby generating a difference block picture. The difference block picture is coded according to two methods depending on whether transform and quantization processes and an entropy coding process are performed or not. Information about whether or not coding is performed on the difference block picture can be included in a bit stream. The two methods are described below.

(1) If transform and quantization processes are performed, a difference block picture between a current block picture and a prediction block picture is transformed, quantized, and then subject to entropy coding, thereby outputting a bit stream. Quantized coefficients prior to the entropy coding are dequantized, inversely transformed, and then added to the prediction block picture, thereby restoring the current block picture.

(2) If transform and quantization processes are not performed, a current block picture includes only a prediction block picture. Here, a difference block picture between the current block picture and the prediction block picture is not coded, and only information about whether the difference block picture is coded or not can be included in a bit stream.

Furthermore, information for generating a prediction block picture for a current block (i.e., information about an intra-frame prediction direction or inter-frame prediction motion information) can be configured based on information about neighboring blocks. Here, information about the generation of the prediction block and a difference block picture are not coded, and only information about whether or not coding has been performed on the information about the generation of the prediction block and the difference block picture can be included in a bit stream. Furthermore, arithmetic coding can be stochastically performed on information about whether or not to code the difference block by taking information about whether neighboring blocks neighboring the current block have been coded or not into consideration.

Method of Filtering and Sampling Depth Information Map

A depth information map has a very simple characteristic and has the same depth value, in particular, in a background part or the inside of the object. Accordingly, filtering (e.g., a deblocking filter, a Sample Adaptive Offset (SAO) filter, an Adaptive Loop Filter (ALF), and In-loop Joint inter-View Depth Filtering (JVDF)) may not be performed on the depth information map. Alternatively, weak filtering may be performed or filtering itself may not be performed on the background part or the inside of the object in the depth information map.

In an embodiment, a deblocking filter may be weakly performed or the deblocking filter may not be performed on a depth information map.

Furthermore, an SAO filter may not be applied to a depth information map.

Furthermore, an ALF may be applied to the boundary part of the object or the inside part of the object in a depth information map or both or the ALF may be applied to only the background part or both. Alternatively, the ALF may not be applied to the depth information map.

Furthermore, JVDF may be applied to the boundary part of the object or the inside part of the object in a depth information map or both or the JVDF may be applied to only the background part or both.

Alternatively, JVDF may not be applied to a depth information map.

Furthermore, any filtering may not be applied to a depth information map.

Furthermore, in general, when coding a depth information map, the original depth information map is down-sampled and coded. When a depth information map is actually used, a decoded depth information map is up-sampled and used. In general, a 4-tap or 6-tap up-sampling (or down-sampling) filter is used in this sampling process. This sampling filter is disadvantageous in that complexity is high and, in particular, is not suitable for an image having a monotonous characteristic like a depth information map. Accordingly, it is required that an up-sampling and down-sampling filter suitable for the characteristics of a depth information map be very easy and simple.

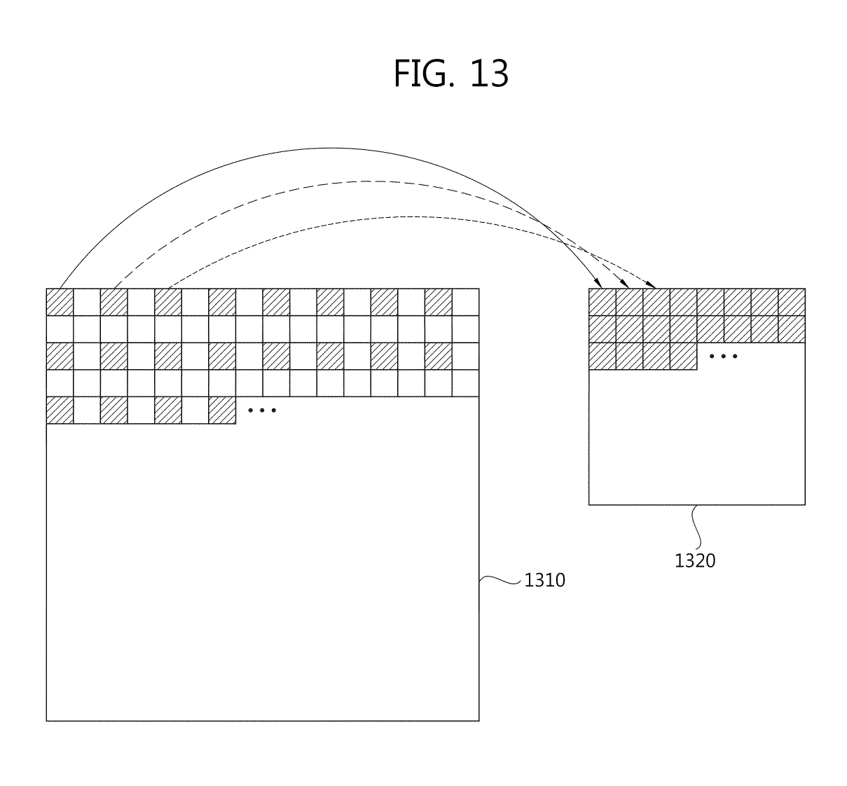

FIG. 13 is a diagram showing an example of a method of down-sampling a depth information map.

As shown in FIG. 13, a down-sampled depth information map 1320 can be configured by copying one sample per 4 pixels from a depth information map 1310 having the original size.

This method may be used only in a background part or the inside of the object in a depth information map.

Alternatively, since the depth information map in the background part or the inside of the object has the same depth value, any depth value of a current block (or a specific region) can be applied to all pixels of a down-sampled depth information map block (or a specific region) without performing a sampling process.

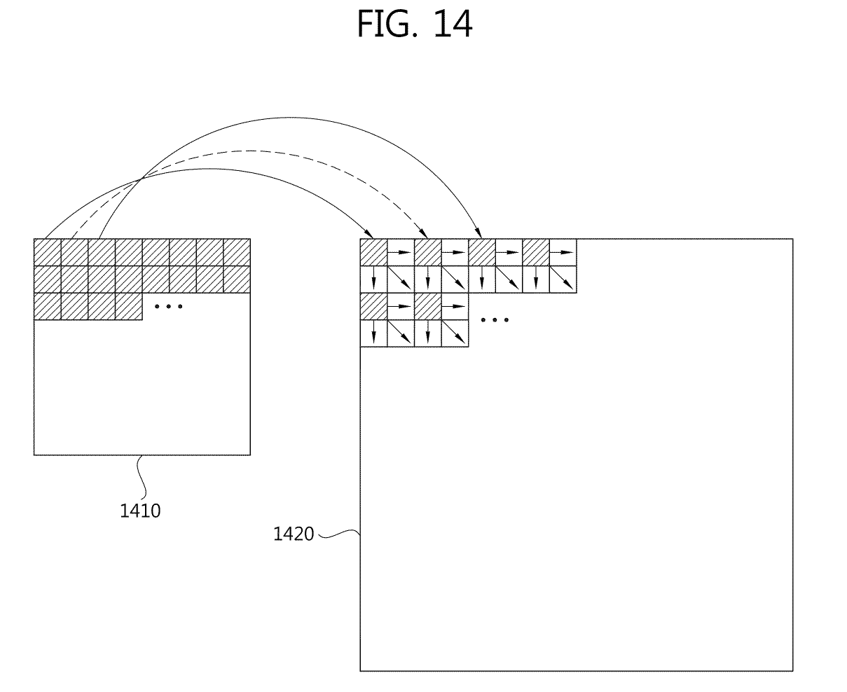

FIG. 14 is a diagram showing an example of a method of up-sampling a depth information map.

As shown in FIG. 14, one sample can be copied from a down-sampled depth information map 1410 and copied (or padded) to 4 pixels of an up-sampled depth information map 1420.

This method may be used only in a background part or the inside of the object in a depth information map.

Alternatively, any depth value of a current block (or specific region) can be applied to all pixels of an up-sampled depth information map block (or specific region) without performing an up-sampling process because the depth information map of a background part or the inside of the object has the same depth value.

Complexity due to up-sampling for a depth information map can be reduced. Furthermore, a depth information map can be used in the state in which up-sampling has been performed on the depth information map because an up-sampled depth information map requires more memory than that of a depth information map prior to up-sampling.

Intra-Frame Coding Method for Depth Information Map and Method of Filtering and Sampling Depth Information Map

In accordance with an example of the present invention, a depth information map can be coded by a combination of an intra-frame coding method for a depth information map and a method of filtering and sampling a depth information map, and an embodiment thereof is described below.

In accordance with an embodiment of the present invention, a method of configuring a current block picture using only a prediction block and controlling filtering strength bS of a deblocking filter for the prediction block or determining whether or not to apply the deblocking filter is described below.

From among the aforementioned intra-frame prediction methods, a method of inferring an intra-frame prediction direction for a current block from neighboring blocks that neighbor the current block, that is, a method of configuring the current block using only the intra-frame prediction block, can be called an intra-skip mode. A block selected according to this intra-skip mode has a very high correlation with neighboring blocks. Accordingly, in this case, a deblocking filtering may not be performed.

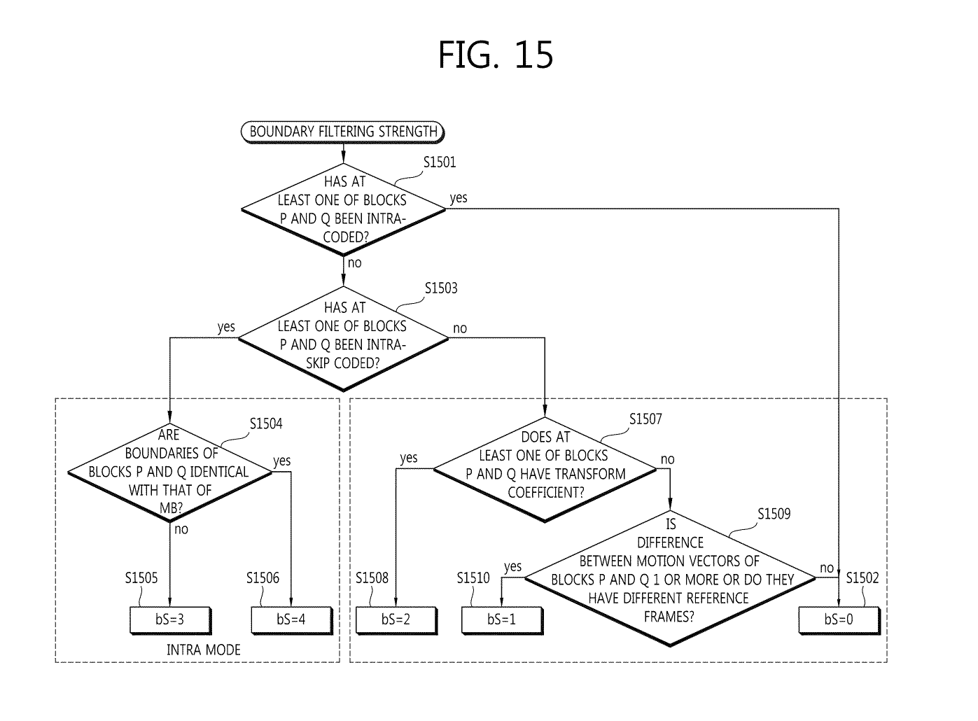

FIG. 15 is a control flowchart illustrating a method of determining boundary filtering strength bS of deblocking filtering in accordance with an embodiment of the present invention.

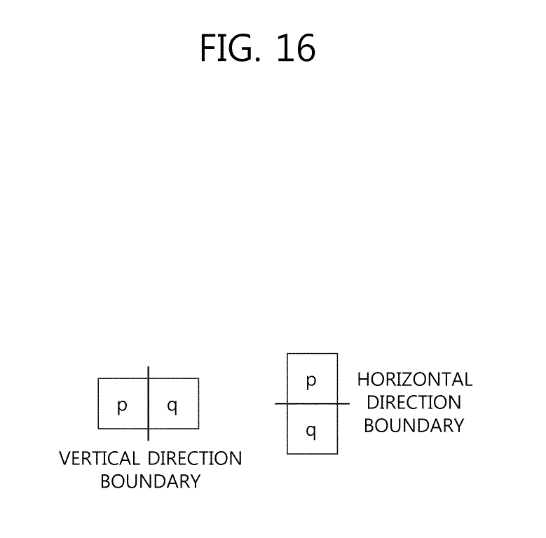

Furthermore, FIG. 16 is a diagram showing the boundary of a neighboring block ‘p’ and a block ‘q’.

A method of determining boundary filtering strength bS of deblocking filtering in the intra-skip mode is described below with reference to FIGS. 15 and 16.

First, as shown in FIG. 16, the blocks ‘p’ and ‘q’ correspond to neighboring blocks that share a boundary. The block ‘p’ is located on the left side of the boundary in a vertical direction, and the block ‘p’ indicates a block located on the upper side of the boundary in a horizontal direction. The block ‘q’ is located on the right side of the boundary in the vertical direction, and the block ‘q’ indicates a block located on the lower side of the boundary in the horizontal direction.

In order to determine the boundary filtering strength bS, first, coding modes of the neighboring blocks ‘p’ and ‘q’ can be checked. Here, the meaning that the block ‘p’ or ‘q’ has been subjected to intra-coding or inter-coding can mean that the block ‘p’ or ‘q’ is an intra-coded macro block or the block ‘p’ or ‘q’ belongs to an intra-coded macro block.

Referring to FIG. 15, in order to determine the boundary filtering strength bS, first, whether or not at least one of the neighboring blocks ‘p’ and ‘q’ has been coded in the intra-skip mode is determined at step S1501.

Here, the intra-skip mode can be considered to be an intra-mode (e.g., N×N prediction mode, wherein N is 16, 8, or 4) and to be without difference data. Alternatively, a mode that is an intra-mode (i.e., N×N prediction mode, wherein N is 16, 8, or 4) and that does not include difference data can be considered to be the intra-skip mode.

If, as a result of the determination at step S1501, it is determined that at least one of the blocks ‘p’ and ‘q’ has been coded in the intra-skip mode, the boundary filtering strength bS can be determined as ‘0’ at step S1502. The meaning that the boundary filtering strength bS is 0 indicates that filtering is not performed in a subsequent filtering application procedure.

In contrast, if, as a result of the determination at step S1501, it is determined that at least one of the blocks ‘p’ and ‘q’ has not been coded in the intra-skip mode, whether or not at least one of the blocks ‘p’ and ‘q’ is an intra-coded block (i.e., block not in the intra-skip block) is determined at step S1503.

If, as a result of the determination at step S1503, it is determined that at least one of the blocks ‘p’ and ‘q’ is an intra-coded block, the process can proceed to an ‘INTRA MODE’ step. In contrast, if, as a result of the determination at step S1503, it is determined that at least one of the blocks ‘p’ and ‘q’ is not an intra-coded block, that is, both the blocks ‘p’ and ‘q’ have been inter-coded, the process can proceed to an ‘INTER MODE’ step.

Here, the inter-coding means prediction coding in which an image of a reconfigured frame having a different time from a current frame is used as a reference frame.

If, as a result of the determination at step S1503, it is determined that at least one of the blocks ‘p’ and ‘q’ is an intra-coded block, in the ‘INTRA MODE’ step, whether or not a boundary of the blocks ‘p’ and ‘q’ is identical with a boundary of a macro block MB is determined at step S1504.

If, as a result of the determination at step S1504, it is determined that the boundary of the blocks ‘p’ and ‘q’ is identical with the boundary of the macro block MB, the boundary filtering strength bS can be determined as 4 at step S1506. If the boundary filtering strength bS is 4, it means that the strongest filtering strength is applied in a subsequent filtering application procedure. The strength of filtering becomes weak as a value of the boundary filtering strength bS is reduced.

In contrast, if, as a result of the determination at step S1504, it is determined that the boundary of the blocks ‘p’ and ‘q’ is not identical with the boundary of the macro block MB, the boundary filtering strength bS can be determined as 3 at step S1505.

In contrast, if, as a result of the determination at step S1503, it is determined that both the blocks ‘p’ and ‘q’ are inter-coded blocks, in the ‘INTER MODE’ step, whether or not at least one of the blocks ‘p’ and ‘q’ has orthogonal transform coefficients (or non-zero transform coefficients) is determined at step S1507.

The orthogonal transform coefficient may also be called a coded coefficient or a non-zero transformed coefficient.

If, as a result of the determination at step S1507, it is determined that at least one of the blocks ‘p’ and ‘q’ has orthogonal transform coefficients, the boundary filtering strength bS is determined as 2 at step S1508.

In contrast, if, as a result of the determination at step S1507, it is determined that at least one of the blocks ‘p’ and ‘q’ does not have orthogonal transform coefficients, whether or not a difference between the absolute values of one component, that is, an x-axis component or a y-axis component, of a motion vector for the blocks ‘p’ and ‘q’ is equal to or greater than 1 (or 4) or whether or not reference frames for the blocks ‘p’ and ‘q’ in motion compensation differ from each other or correspond to different PU partition boundaries or both are determined at step S1509.

Here, the meaning that ‘the reference frames differ from each other’ can include both that the reference frames themselves differ from each other and the numbers of reference frames differ from each other.

If, as a result of the determination at step S1509, it is determined that a difference between the absolute values of one component is greater than 1 (or 4) or the reference frames in motion compensation differ from each other, the boundary filtering strength bS can be determined as 1 at step S1510.

In contrast, if, as a result of the determination at step S1509, it is determined that a difference between the absolute values of one component is smaller than 1 (or 4) or the reference frames in motion compensation are the same, the boundary filtering strength bS can be determined as 0 at step S1502.

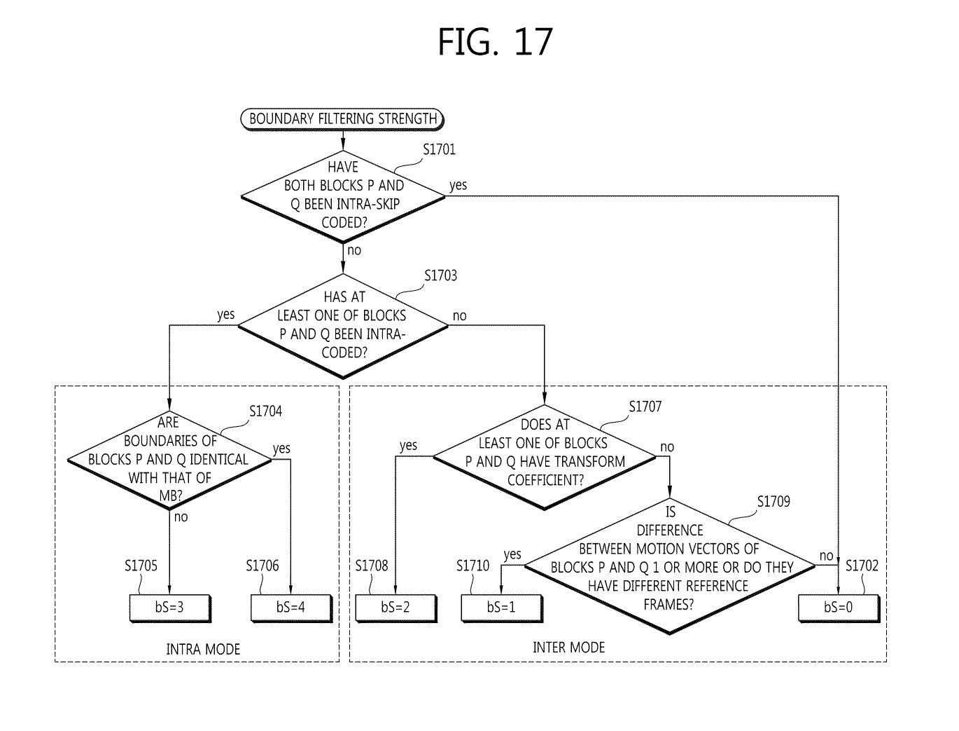

FIG. 17 is a control flowchart illustrating a method of determining boundary filtering strength bS of deblocking filtering in accordance with another embodiment of the present invention.

Referring to FIG. 17, first, in order to determine the boundary filtering strength bS, whether or not both the blocks ‘p’ and ‘q’ have been coded in the intra-skip mode is determined at step S1701.

If, as a result of the determination at step S1701, it is determined that both the blocks ‘p’ and ‘q’ have been coded in the intra-skip mode, the boundary filtering strength bS of the blocks ‘p’ and ‘q’ can be set to ‘0’ at step S1702.

Alternatively, if both the blocks ‘p’ and ‘q’ have been coded in the intra-skip mode, the boundary filtering strength bS can be set weakly (or strongly). In this case, in an embodiment, the boundary filtering strength bS can be set to a specific value, or filtering may not be performed.

Meanwhile, if, as a result of the determination at step S1701, it is determined that both the blocks ‘p’ and ‘q’ have not been coded in the intra-skip mode, whether or not at least one of the blocks ‘p’ and ‘q’ is an intra-coded block (i.e., block not in the intra-skip block) is determined at step S1703.

If, as a result of the determination at step S1703, it is determined that at least one of the blocks ‘p’ and ‘q’ is an intra-coded block, the process can proceed to an ‘INTRA MODE’ step. In contrast, if, as a result of the determination at step S1703, it is determined that at least one of the blocks ‘p’ and ‘q’ is not an intra-coded block, that is, both the blocks ‘p’ and ‘q’ have been inter-coded, the process can proceed to an ‘INTER MODE’ step.

If at least one of the blocks ‘p’ and ‘q’ is an intra-coded block, in the ‘INTRA MODE’ step, whether or not a boundary of the blocks ‘p’ and ‘q’ is identical with a boundary of a macro block MB is determined at step S1704.

If, as a result of the determination at step S1704, it is determined that the boundary of the blocks ‘p’ and ‘q’ is identical with the boundary of the macro block MB, the boundary filtering strength bS can be determined as 4 at step S1706. If the boundary filtering strength bS is 4, it means that the strongest filtering strength is applied in a subsequent filtering application procedure. The strength of filtering becomes weak as a value of the boundary filtering strength bS is reduced.

In contrast, if, as a result of the determination at step S1704, it is determined that the boundary of the blocks ‘p’ and ‘q’ is not identical with the boundary of the macro block MB, the boundary filtering strength bS can be determined as 3 at step S1705.

In contrast, if, as a result of the determination at step S1703, it is determined that both the blocks ‘p’ and ‘q’ are inter-coded blocks, in the ‘INTER MODE’ step, whether or not at least one of the blocks ‘p’ and ‘q’ has orthogonal transform coefficients (or non-zero transform coefficients) is determined at step S1707.

The orthogonal transform coefficient may also be called a coded coefficient or a non-zero transformed coefficient.

If, as a result of the determination at step S1707, it is determined that at least one of the blocks ‘p’ and ‘q’ has orthogonal transform coefficients, the boundary filtering strength bS is determined as 2 at step S1708.

In contrast, if, as a result of the determination at step S1707, it is determined that at least one of the blocks ‘p’ and ‘q’ does not have orthogonal transform coefficients, whether or not a difference between the absolute values of one component, that is, an x-axis component or a y-axis component, of a motion vector for the blocks ‘p’ and ‘q’ is equal to or greater than 1 (or 4) or whether or not reference frames for the blocks ‘p’ and ‘q’ in motion compensation differ from each other or correspond to different PU partition boundaries or both are determined at step S1709.

Here, the meaning that ‘the reference frames differ from each other’ can include both that the reference frames themselves differ from each other and the numbers of reference frames differ from each other.

If, as a result of the determination at step S1709, it is determined that a difference between the absolute values of one component is greater than 1 (or 4) or the reference frames in motion compensation differ from each other, the boundary filtering strength bS can be determined as 1 at step S1710.

In contrast, if, as a result of the determination at step S1709, it is determined that a difference between the absolute values of one component is smaller than 1 (or 4) or the reference frames in motion compensation are the same, the boundary filtering strength bS can be determined as 0 at step S1702.

Meanwhile, if at least one of a current block and a neighboring block is in an intra-skip mode, boundary filtering strength between the current block and the neighboring block can be set to ‘0’. Alternatively, the boundary filtering strength can be set weakly (or strongly). In an embodiment, the boundary filtering strength can be set to a specific value, or filtering may not be performed.

In an embodiment, assuming that at least one of a current block and a neighboring block is in an intra-skip mode and the other thereof is in a common coding mode (intra- (or inter-) coding mode), if a block in the common coding mode (intra- (or inter-) coding mode) has any one orthogonal transform coefficient, boundary filtering strength between the current block and the neighboring block can be set to ‘4’ (or 3, 2, 1). In contrast, if the block in the common coding mode (intra- (or inter-) coding mode) does not have any orthogonal transform coefficient, the boundary filtering strength between the current block and the neighboring block can be set to 0 (or 1, 2, or 3). Alternatively, the boundary filtering strength can be set weakly (or strongly). In this case, in an embodiment, the boundary filtering strength can be set to a specific value, or filtering may not be performed.

In another embodiment, assuming that a coding mode of a neighboring block that neighbors a current block is in an intra-skip mode, if the current block and the neighboring block have the same intra-prediction direction, boundary filtering strength between the current block and the neighboring block can be set to ‘0’. If the current block and the neighboring block have different intra-prediction directions, the boundary filtering strength can be set to ‘1’ or another value (2, 3, or 4). Alternatively, the boundary filtering strength can be set weakly (or strongly). In this case, in an embodiment, the boundary filtering strength can be set to a specific value, or filtering may not be performed.

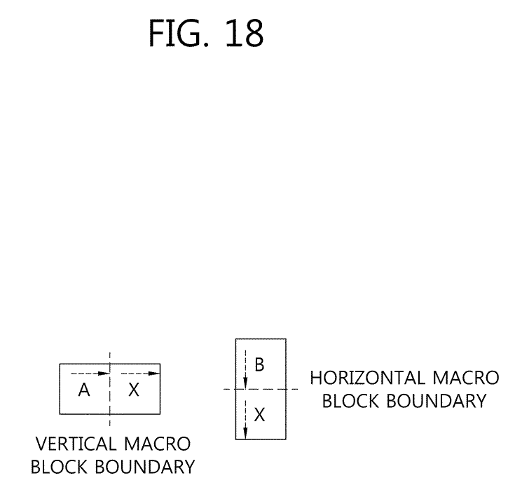

FIG. 18 is a diagram showing the prediction directions and macro block boundaries of a current block and a neighboring block in accordance with an embodiment of the present invention.

For example, referring to FIG. 18, when setting filtering strength of deblocking for the vertical macro block boundary of a current block X, the filtering strength of deblocking can be set to ‘0’ because the prediction direction of a neighboring block A is the same as that of the current block X. Alternatively, the filtering strength of deblocking can be set to weakly (or strongly). In an embodiment, the filtering strength of deblocking may be set to a specific value, or filtering may not be performed. This example can be equally applied to the horizontal boundary of the current block X and a neighboring block B.

Furthermore, if a current block is in an intra-skip mode and an intra-frame prediction direction for the current block is a horizontal direction, boundary filtering strength for a vertical boundary is set to ‘0’ or filtering is not performed. Furthermore, if a current block is in an intra-skip mode and an intra-frame prediction direction for the current block is a vertical direction, boundary filtering strength for a horizontal boundary is set to ‘0’ or filtering is not performed. In other cases, the boundary filtering strength may be set weakly or filtering may not be performed.

For example, referring to FIG. 8, if a current block is in an intra-skip mode and an intra-frame prediction direction for the current block is a horizontal direction, boundary filtering strength for a vertical boundary is set to ‘0’ or filtering is not performed. This example is equally applied to the horizontal boundary of the current block X and the neighboring blocks B. In addition, a method of determining the boundary filtering strength bS can be various.

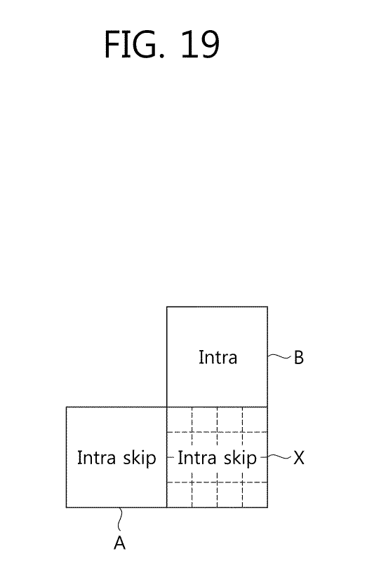

FIG. 19 is a diagram showing a coding mode of a current block and the boundaries of the current block. Each or a combination of the aforementioned methods can be applied to boundaries shown in FIG. 19.

In FIG. 19, the methods can be applied to a macro block (or specific block) boundary, that is, a basic coding module of a current block X. Furthermore, in FIG. 19, the methods can be applied in a block (or specific block) boundary within the current block X.

For example, if the current block X is in an intra-skip mode and a neighboring block A neighboring the current block X on the left side thereof is in an intra-skip mode, a deblocking filter may not be applied to the boundary of the two blocks X and A.

If the current block A is in an intra-skip mode and a neighboring block B neighboring the current block X on the upper side thereof has been coded in an intra-mode, boundary filtering strength for the two blocks X and B can be set to ‘0’. Alternatively, the boundary filtering strength can be set to weakly (or strongly). In an embodiment, the boundary filtering strength can be set to a specific value. Alternatively, whether or not the boundaries of the current block X and the neighboring blocks A and B are identical with the boundary of a macro block can be determined. If, as a result of the determination, it is determined that the boundaries of the current block X and the neighboring blocks A and B are identical with the boundary of the macro block, boundary filtering strength bS can be determined as 4. In contrast, if, as a result of the determination, it is determined that the boundaries of the current block X and the neighboring blocks A and B are not identical with the boundary of the macro block, boundary filtering strength bS can be determined as 3.

This deblocking filter functions to improve subjective picture quality of an image by removing a blocking artifact from the image. However, a depth information map is used to generate a virtual composition image, but is not actually outputted to a display device. Accordingly, the block boundary of this depth information map can be necessary to improve the picture quality of the virtual composition image not to improve the subjective picture quality.

Furthermore, regarding a deblocking filter (or other filtering methods) of a depth information map, it is necessary to determine whether or not to perform filtering and to set filtering strength based on a coding mode (i.e., intra-frame prediction mode or inter-frame prediction mode) between two blocks, the identity of a reference picture between the two blocks, and a coding mode of a current block, not motion information between the two blocks.

For example, if a current block has been coded according to a plane-based partition coding method for coding the boundary part of the object, a deblocking filter needs not to be performed on a block boundary so that the boundary part of the object is not crushed to the highest degree.

For another example, if a current block has been coded in an intra-skip mode and the current block has been horizontally padded and derived from the pixels of neighboring left blocks, pixel values that neighbor the vertical boundary of a corresponding block can be the same. Accordingly, a deblocking filter may not be performed on this block boundary.

On the contrary, in this case, pixel values that neighbor the horizontal boundary of a corresponding block may not be the same. A deblocking filter must be performed on this block boundary. That is, if a current block has been coded into an intra-skip block, filtering can be performed on the boundary in the intra-frame prediction direction of the current block not a correlation with neighboring blocks. Alternatively, whether or not to perform filtering can be determined based on coding modes and intra-frame prediction directions of a current block and a neighboring block.

A method of deriving filtering strength bS of a deblocking filter by combining the aforementioned methods is described below.

If the boundary of a current block is a horizontal boundary, the following process can be performed.

If coding modes of two neighboring blocks on the basis of the boundary of a current block are intra-skip modes (or one of the two neighboring blocks is an intra-skip mode) and an intra-frame direction of a corresponding block is a vertical direction, filtering strength bS of a deblocking filter can be set weakly and can be set to ‘0’, for example.

If at least one of the coding modes of the two neighboring blocks on the basis of the boundary of the current block is an intra-skip mode and the boundary of the corresponding block is the boundary of a macro block (or specific block boundary), however, the filtering strength bS of the deblocking filter can be set strongly and can be set to ‘4’, for example.

If the boundary of the corresponding block is not the boundary of the macro block, however, the filtering strength bS of the deblocking filter can be set weakly and can be set to ‘0’, for example.

Hereinafter, filtering strength bS of a deblocking filter can be applied in accordance with the process of FIG. 17.

If the boundary of a current block is a vertical boundary, the following process can be performed.

If coding modes of two neighboring blocks on the basis of the boundary of the current block are intra-skip modes (or one of the two neighboring blocks is in an intra-skip mode) and an intra-frame direction of a corresponding block is a horizontal direction, filtering strength bS of a deblocking filter can be set weakly and can be set to ‘0’, for example.

If at least one of the coding modes of the two neighboring blocks on the basis of the boundary of the current block is an intra-skip mode and the boundary of the corresponding block is the boundary of a macro block (or the boundary of a specific block), however, the filtering strength bS of the deblocking filter can be set strongly and can be set to ‘4’, for example. If the boundary of the corresponding block is not the boundary of the macro block, however, the filtering strength bS of the deblocking filter can be set weakly and can be set to ‘0’, for example.

Hereinafter, filtering strength bS of a deblocking filter can be applied in accordance with the process of FIG. 17.

Alternatively, the filtering strength bS of the deblocking filter can be set weakly in the boundary part of the object in a depth information map to which the plane-based partition intra-frame prediction method of FIG. 8 has been applied. In this case, the filtering strength bS can be set to ‘0’, for example. As an embodiment using this method, a process of deriving the filtering strength bS of the deblocking filter can be performed as follows. The following method can be applied when the boundary of a current block is a horizontal boundary or a vertical boundary or both.

If both coding modes of two neighboring blocks on the basis of the boundary of a current block are modes to which the plane-based partition intra-frame prediction method has been applied (or one of the two neighboring blocks) and the boundary of a corresponding block is the boundary of a macro block (or the boundary of a specific block), filtering strength bS of a deblocking filter can be set weakly and can be set to ‘1’, for example.

If the boundary of the corresponding block is not the boundary of the macro block, however, the filtering strength bS of the deblocking filter can be set weakly and can be set to ‘0’, for example.

If only intra-frame coding is performed (e.g., in an I frame), a macro block layer syntax can be the same as that of Table 1 below when the proposed methods are implemented according to H.264/AVC that is an international moving picture standard.

TABLE 1

| | | |
|---|---|---|
| | | Descrip- |
| slice_data ( ) { | C | tor |
| if (entropy_coding_mode_flag) | | |
| while (!byte_aligned ( )) | | |
| cabac_alignment_one_bit | 2 | f(1) |
| CurrMbAddr = first_mb_in_slice * (1 + MbaffFrameFlag) | | |
| moreDataFlag = 1 | | |
| prevMbSkipped = 0 | | |
| do { | | |
| if (slice_type != I && slice_type != SI) | | |
| { | | |
| if (!entropy_coding_mode_flag) { | | |
| mb_skip_run | 2 | ue(v) |
| prevMbSkipped = (mb_skip_run > 0) | | |
| for (i=0; i<mb_skip_run; i++) | | |
| CurrMbAddr = NextMbAddress (CurrMbAddr) | | |
| moreDataFlag = more_rbsp_data ( ) | | |
| } else { | | |
| mb_skip_flag | 2 | ae(v) |
| moreDataFlag = !mb_skip_flag | | |
| } | | |
| } | | |
| else if (slice_type == I \|\| slice_type == SI) | | |
| { | | |
| if (!entropy_coding_mode_flag) { | | |
| mb_intra_skip_run | 2 | ue(v) |
| prevMbSkipped = (mb_intra_skip_run > 0) | | |
| for (i=0; i<mb_intra_skip_run; i++) | | |
| CurrMbAddr = NextMbAddress (CurrMbAddr) | | |
| moreDataFlag = more_rbsp_data ( ) | | |
| } else { | | |
| mb_intra_skip_flag | 2 | ae(v) |
| moreDataFlag = !mb_intra_skip_flag | | |
| } | | |
| } | | |
| if (moreDataFlag) { | | |
| if (MbaffFrameFlag && (CurrMbAddr % 2 == 0 \|\| | | |
| (CurrMbAddr % 2 == 1 && prevMbSkipped))) | | |
| mb_field_decoding_flag | 2 | u(1)\| |
| macroblock_layer ( ) | 2\|3\|4 | ae(v) |
| } | | |
| if (!entropy_coding_mode_flag) | | |
| moreDataFlag = more_rbsp_data ( ) | | |
| else { | | |
| if (slice_type != \|&& slice_type != SI) | | |
| prevMbSkipped = mb_skip_flag | | |
| if (slice_type == I \|\| slice_type == SI) | | |
| prevMbSkipped = mb_intra_skip_flag | | |
| if (MbaffFrameFlag && CurrMbAddr % 2 == 0) | | |
| moreDataFlag = 1 | | |
| else { | | |
| end_of_slice_flag | 2 | ae(v) |
| moreDataFlag = !end_of_slice_flag | | |
| } | | |
| } | | |
| CurrMbAddr = NextMbAddress (CurrMbAddr) | | |
| }while (moreDataFlag) | | |
| } | | |

‘mb_intra_skip_run’ and ‘mb_intra_skip_flag’ mean that a current depth information map block includes only a prediction picture. The meaning that the current depth information map block includes only a prediction picture can mean that the current depth information map block has an intra-skip mode. Furthermore, it can be interpreted that the current depth information map block has an intra-mode (e.g., N×N prediction mode, wherein N is 16, 8, 4, etc.) and does not have difference data.

In ‘mb_intra_skip_run’, an entropy coding method operates in Context Adaptive Variable Length Coding (CAVLC). In ‘mb_intra_skip_flag’, an entropy coding method operates in Context Adaptive Binary Arithmetic Coding (CABAC).

In the above syntax, ‘moreDataFlag’ indicates whether or not to parse coding information (i.e., information about the generation of a prediction block and information about a residual signal block) about a current block. If a value of ‘moreDataFlag’ is ‘1’, it indicates that coding information about a current block is parsed. If a value of ‘moreDataFlag’ is ‘0’, it indicates that coding information about a current block is not parsed and the process proceeds to a next block.

If a value of ‘mb_intra_skip_flag’ is ‘1’, coding information about a current block is not parsed and the process proceeds to a next block because ‘moreDataFlag’ is set to ‘0’. In other words, if a value of ‘mb_intra_skip_flag’ is ‘1’, coding information (i.e., information about the generation of a prediction block and information about a residual signal block) about a current block is not parsed.

Furthermore, if both intra-frame coding and inter-frame coding are sought to be performed (e.g., in I or P or B frame), a macro block layer syntax is the same as that of Table 2 below when the proposed methods are implemented according to H.264/AVC that is an international moving picture standard.

TABLE 2

| | | |
|---|---|---|
| macroblock_layer ( ) { | C | Descriptor |
| if (! mb_skip_flag) | | |
| intra_skip_flag | 2 | u(1)\|ae(v) |
| if (!intra_skip_flag) { | | |
| mb_type | 2 | ue(v)\|ae(v) |
| if (mb_type == I_PCM) { | | |
| while (!byte_aligned ( )) | | |
| pcm_alignment_zero_bit | 2 | f(1) |
| for (i = 0; i < 256; i++) | | |
| pcm_sample_luma[ i ] | 2 | u(v) |
| for (i = 0; i < 2 * MbWidthC * MbHeightC; i++) | | |
| pcm_sample_chroma[ i ] | 2 | u(v) |
| } else { | | |
| noSubMbPartSizeLessThan8x8Flag = 1 | | |
| if (mb_type != I_NxN && | | |
| MbPartPredMode (mb_type, 0) != Intra_16x16 | | |
| && | | |
| NumMbPart (mb_type) == 4) { | | |
| sub_mb_pred (mb_type) | 2 | |
| for (mbPartIdx = 0; mbPartIdx < 4; mbPartIdx++) | | |
| if (sub_mb_type[ mbPartIdx ] != | | |
| B_Direct_8x8) { | | |
| if (NumSubMbPart | | |
| (sub_mb_type[ mbPartIdx ]) | | |
| > 1) | | |
| noSubMbPartSizeLessThan8x8Flag = 0 | | |
| } else if (!direct_8x8_inference_flag) | | |
| noSubMbPartSizeLessThan8x8Flag = 0 | | |
| } else { | | |
| if (transform_8x8_mode_flag && mb_type == | | |
| I_NxN) | | |
| transform_size_8x8_flag | 2 | u(1)\|ae(v) |
| mb_pred (mb_type) | 2 | |
| } | | |
| if (MbPartPredMode (mb_type, 0) != Intra_16x16) { | | |
| coded_block_pattern | 2 | me(v)\|ae(v) |
| if (CodedBlockPatternLuma > 0 && | | |
| transform_8x8_mode_flag && mb_type!= | | |
| I_NxN && | | |
| noSubMbPartSizeLessThan8x8Flag&& | | |
| (mb_type != B_Direct_16x16 \|\| | | |
| direct_8x8_inference_flag)) | | |
| transform_size_8x8_flag | 2 | u(1)\|ae(v) |
| } | | |
| if (CodedBlockPatternLuma > 0 \|\| | | |
| CodedBlockPatternChroma > 0 \|\| MbPartPredMode | | |
| (mb_type, 0) == Intra_16x16) { | | |
| mb_qp_delta | 2 | se(v)\|ae(v) |
| residual ( ) | 3\|4 | |
| } | | |
| } | | |
| } | | |

‘mb_intra_skip_flag’ means that a current depth information map block includes only a prediction picture. If a value of ‘mb_intra_skip_flag’ is ‘1’, the data of a difference block is not parsed. If a value of ‘mb_intra_skip_flag’ is ‘0’, the data of a difference block is parsed as in an existing method. Here, the meaning that the data of the difference block is not parsed can mean that the data has an intra-skip mode. Furthermore, it can be interpreted that the data has an intra-mode (e.g., N×N prediction mode, wherein N is 16, 8, 4, etc.) and does not have difference data.

In the above syntax, if a value of ‘mb_intra_skip_flag’ is ‘1’, ‘mb_type’, ‘sub_mb_pred (mb_type)’, ‘mb_pred (mb_type)’, ‘coded_block_pattern’, ‘transform_size_{—}8×8_flag’, ‘mb_qp_delta’, ‘residual( )’, etc. are not parsed. That is, if a value of ‘mb_intra_skip_flag’ is ‘1’, coding information about a current block (i.e., information about the generation of a prediction block and information about a residual signal block) is not parsed.

Tables 3 to 5 can be obtained by applying the syntax of Table 2 to a ‘slice_data( )’ syntax.

TABLE 3

| | | |
|---|---|---|
| slice_data ( ) { | C | Descriptor |
| if (entropy_coding_mode_flag) | | |
| while (!byte_aligned ( )) | | |
| cabac_alignment_one_bit | 2 | f(1) |
| CurrMbAddr = first_mb_in_slice * (1 + | | |
| MbaffFrameFlag) | | |
| moreDataFlag = 1 | | |
| prevMbSkipped = 0 | | |
| do { | | |
| if (slice_type != I && slice_type != SI) | | |
| if (!entropy_coding_mode_flag) { | | |
| mb_skip_run | 2 | ue(v) |
| prevMbSkipped = (mb_skip_run > 0) | | |
| for (i=0; i<mb_skip_run; i++) | | |
| CurrMbAddr = NextMbAddress | | |
| (CurrMbAddr) | | |
| moreDataFlag = more_rbsp_data ( ) | | |
| if (moreDataFlag && (slice type == P \|\| | | |
| slice_type == B)) { | | |
| mb_intra_skip_flag | 2 | f(1) |
| moreDataFlag = !mb_intra_skip_flag | | |
| } | | |
| } else { | | |
| mb_skip_flag | 2 | ae(v) |
| moreDataFlag = !mb_skip_flag | | |
| if (moreDataFlag && (slice_type == P \|\| | | |
| slice type == B)) { | | |
| mb_intra_skip_flag | 2 | ae(v) |
| moreDataFlag = !mb_intra_skip_flag | | |
| } | | |
| } | | |
| if (moreDataFlag) { | | |
| if (MbaffFrameFlag && (CurrMbAddr | | |
| % 2 == 0\|\| | | |
| (CurrMbAddr % 2 == 1 && | | |
| prevMbSkipped))) | | |
| mb_field_decoding_flag | 2 | u(1)\|ae(v) |
| macroblock_layer ( ) | 2\|3\|4 | |
| } | | |
| if (!entropy_coding_mode_flag) | | |
| moreDataFlag = more_rbsp_data ( ) | | |
| else { | | |
| if (slice_type != I && slice_type != SI) | | |
| prevMbSkipped = mb skip flag | | |
| if (MbaffFrameFlag && CurrMbAddr % 2 == 0) | | |
| moreDataFlag = 1 | | |
| else { | | |
| end_of_slice_flag | 2 | ae(v) |
| moreDataFlag = !end_of_slice_flag | | |
| } | | |
| } | | |
| CurrMbAddr = NextMbAddress (CurrMbAddr) | | |
| } while (moreDataFlag) | | |
| } | | |

TABLE 4

| | | |
|---|---|---|
| slice data ( ) { | C | Descriptor |
| if (entropy_coding_mode_flag) | | |
| while (!byte_aligned ( )) | | |
| cabac_alignment_one_bit | 2 | f(1) |
| CurrMbAddr = first_mb_in_slice * (1 + | | |
| MbaffFrameFlag) | | |
| moreDataFlag = 1 | | |
| prevMbSkipped = 0 | | |
| do { | | |
| if (slice_type != I && slice_type != SI) | | |
| if (!entropy_coding_mode_flag) { | | |
| mb_skip_run | 2 | ue(v) |
| prevMbSkipped = (mb_skip_run > 0) | | |
| for (i=0; i<mb_skip_run; i++) | | |
| CurrMbAddr = NextMbAddress | | |
| (CurrMbAddr) | | |
| moreDataFlag = more_rbsp_data ( ) | | |
| if (moreDataFlag) { | | |
| mb_intra_skip_flag | 2 | f(1) |
| moreDataFlag = !mb_intra_skip_flag | | |
| } | | |
| } else { | | |
| mb_skip_flag | 2 | ae(v) |
| moreDataFlag = !mb_skip_flag | | |
| if (moreDataFlag){ | | |
| mb_intra_skip_flag | 2 | ae(v) |
| moreDataFlag =!mb_intra_skip_flag | | |
| } | | |
| } | | |
| if (moreDataFlag) { | | |
| if (MbaffFrameFlag&&(CurrMbAddr % | | |
| 2== 0\|\| | | |
| (CurrMbAddr % 2==1 | | |
| && prevMbSkipped))) | | |
| mb_field_decoding_flag | 2 | u(1)\|ae(v) |
| macroblock_layer ( ) | 2\|3\|4 | |
| } | | |
| if (!entropy_coding_mode_flag) | | |
| moreDataFlag = more_rbsp_data ( ) | | |
| else { | | |
| if (slice_type != I && slice_type != SI) | | |
| prevMbSkipped = mb_skip_flag | | |
| if (MbaffFrameFlag && CurrMbAddr % | | |
| 2 == 0) | | |
| moreDataFlag = 1 | | |
| else { | | |
| end_of_slice_flag | 2 | ae(v) |
| moreDataFlag = !end_of_slice_flag | | |
| } | | |
| } | | |
| CurrMbAddr = NextMbAddress | | |
| (CurrMbAddr) | | |
| } while (moreDataFlag) | | |
| } | | |

TABLE 5

| | | |
|---|---|---|
| slice data ( ) { | C | Descriptor |
| if (entropy_coding_mode_flag) | | |
| while (!byte_aligned ( )) | | |
| cabac_alignment_one_bit | 2 | f(1) |
| CurrMbAddr = first_mb_in_slice * (1 + | | |
| MbaffFrameFlag) | | |
| moreDataFlag = 1 | | |
| prevMbSkipped = 0 | | |
| do { | | |
| if (slice_type != I && slice_type != SI) | | |
| if (!entropy_coding_mode_flag) { | | |
| mb_intra_skip_run | 2 | ue(v) |
| prevMbSkipped = (mb_intra_skip_run > 0) | | |
| for (i=0; i<mb_intra_skip_run; i++) | | |
| CurrMbAddr = NextMbAddress | | |
| (CurrMbAddr) | | |
| moreDataFlag = more_rbsp_data ( ) | | |
| if (moreDataFlag) { | | |
| mb_skip_flag | 2 | f(1) |
| moreDataFlag = !mb_skip_flag | | |
| } | | |
| } else } | | |
| mb_intra_skip_flag | 2 | ae(v) |
| moreDataFlag = !mb_intra_skip_flag | | |
| if (moreDataFlag){ | | |
| mb_skip_flag | 2 | ae(v) |
| moreDataFlag = !mb_skip_flag | | |
| } | | |
| } | | |
| if (moreDataFlag) { | | |
| if (MbaffFrameFlag && (CurrMbAddr % 2 == 0 \|\| | | |
| (CurrMbAddr % 2 == 1 && | | |
| prevMbSkipped))) | | |
| mb_field_decoding_flag | 2 | u(1)\|ae(v) |
| macroblock layer ( ) | 2\|3\|4 | |
| } | | |
| if (!entropy_coding_mode_flag) | | |
| moreDataFlag = more_rbsp_data ( ) | | |
| else { | | |
| if (slice_type != I && slice_type != SI) | | |
| prevMbSkipped = mb_skip_flag | | |
| if (MbaffFrameFlag && CurrMbAddr % 2 == 0) | | |
| moreDataFlag = 1 | | |
| else { | | |
| end_of_slice_flag | 2 | ae(v) |
| moreDataFlag = !end_of_slice_flag | | |
| } | | |
| } | | |
| CurrMbAddr = NextMbAddress (CurrMbAddr) | | |
| }while (moreDataFlag) | | |
| } | | |

In Tables 3 to 5, ‘moreDataFlag’ indicates whether or not to parse coding information about a current block (i.e., information about the generation of a prediction block and information about a residual signal block).

If a value of ‘moreDataFlag’ is ‘1’, it indicates that coding information about a current block is parsed. If a value of ‘moreDataFlag’ is ‘0’, it indicates that coding information about a current block is not parsed and the process proceeds to a next block.

If a value of ‘mb_intra_skip_flag’ is ‘1’, coding information about a current block is not parsed and the process proceeds to a next block because ‘moreDataFlag’ is set to ‘0’. In other words, if a value of ‘mb_intra_skip_flag’ is ‘1’, coding information about a current block (i.e., information about the generation of a prediction block and information about a residual signal block) is not parsed.

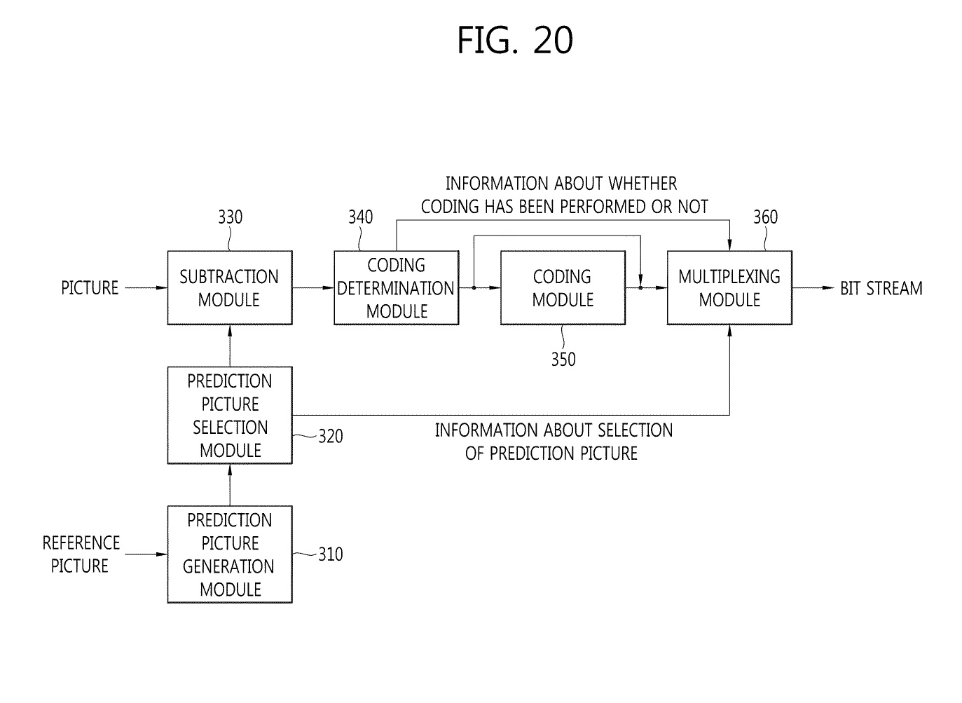

FIG. 20 is a control block diagram showing the construction of a video coding apparatus in accordance with an embodiment of the present invention. FIG. 20 is a diagram showing the coding apparatus using a method of configuring a current block picture using only a prediction block employing a neighboring block when performing intra-frame coding on an image having a high correlation between pixels.

A prediction picture generation module 310 generates a prediction block through an intra-frame prediction process or generates a prediction block through an inter-frame prediction process. A detailed method of generating the prediction block has been described above.

A prediction picture selection module 320 selects a prediction picture having the best coding efficiency from prediction pictures generated from the prediction picture generation module 310. Information about the selection of the prediction picture is included in a bit stream.

A subtraction module 330 generates a difference block picture based on a difference between a current block picture and a prediction block picture.

A coding determination module 340 determines whether or not to code the difference block picture and information about the generation of the prediction block and outputs information about whether coding has been performed or not.

A coding module 350 performs coding based on the information about whether coding has been performed or not, determined by the coding determination module 340, and outputs a bit stream obtained by performing transform and quantization, entropy coding, and compressing processes on the difference block picture.

A multiplexing module 360 outputs one bit stream by mixing the bit stream for the difference block picture compressed and outputted by the coding module 350, the information about whether coding has been performed or not, outputted by the coding determination module 340, and the information about the selection of the prediction picture, outputted by the prediction picture selection module 320.

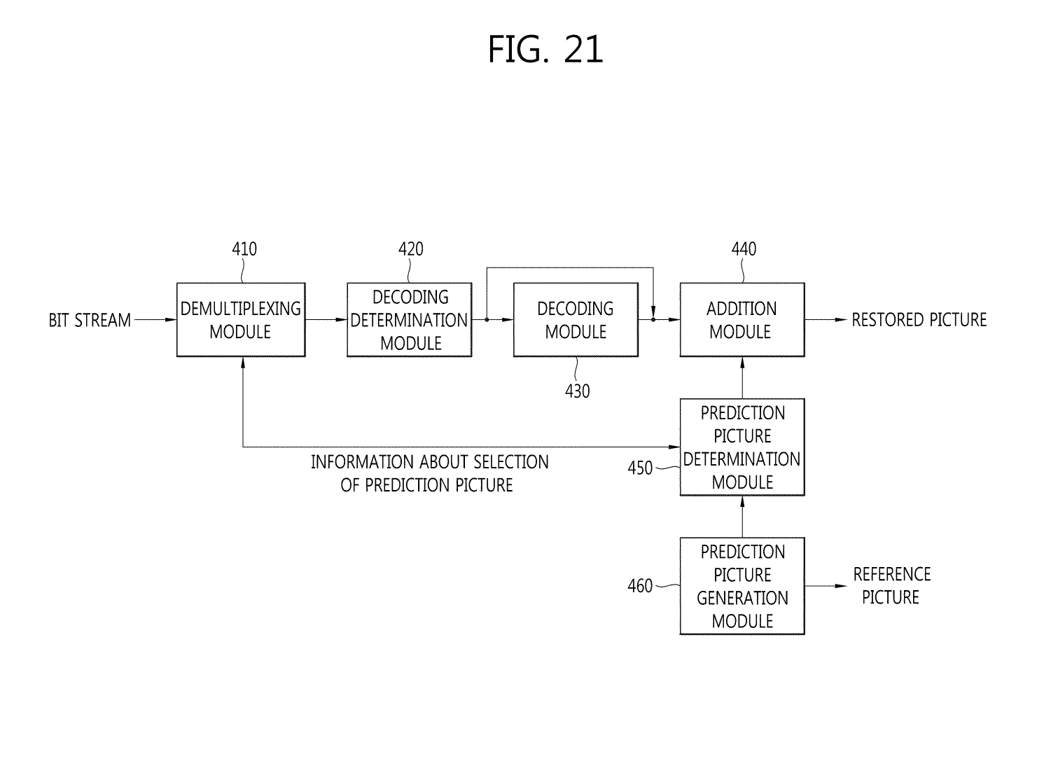

FIG. 21 is a control block diagram showing the construction of a video decoding apparatus in accordance with an embodiment of the present invention. FIG. 21 is a diagram showing the decoding apparatus using a method of configuring a current block picture using only a prediction block employing a neighboring block when performing intra-frame coding on an image having a high correlation between pixels.

A demultiplexing module 410 decodes information about whether decoding has been performed or not and information about the selection of a prediction picture, regarding whether or not information about a difference picture is included in a received bit stream.

A decoding determination module 420 determines whether the decoding module 430 will perform decoding or not based on the information about whether decoding has been performed or not.

The decoding module 430 performs decoding only when information about a difference picture and the generation of a prediction block are included in a bit stream, based on the information about whether decoding has been performed or not. The decoding module 430 restores the difference picture through a dequantization process and an inverse transform process.

A prediction picture generation module 460 generates a prediction block through an intra-frame prediction process or an inter-frame prediction process.

A prediction picture determination module 450 determines an optimal prediction picture for a current block, from among prediction picture generated from the prediction picture generation module 460, based on the information about the selection of the prediction picture.

An addition module 440 configures a restored image by adding the generated prediction picture and the restored difference picture. Here, if the restored difference picture is not present, the prediction picture includes the restored image.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

The above-described embodiments include various aspects of examples. Although all kinds of possible combinations for representing the various aspects may not be described, a person having ordinary skill in the art will understand that other possible combinations are possible. Accordingly, the present invention should be construed as including all other replacements, modifications, and changes which fall within the scope of the claims.

1. A video decoding method, comprising:
generating a prediction pixel value of a neighboring block neighboring a current block as a pixel value of the current block when performing intra-frame prediction on a depth information map.

2. The video decoding method of claim 1, further comprising:
demultiplexing information about a coded difference picture, information about whether or not the coded difference picture has been decoded, and selection information about a method of generating a prediction block picture;
decoding information about whether the current block has been decoded or not in a received bit stream;
decoding information about a difference picture for the current block and information about a generation of a prediction block based on the information about whether or not the coded difference picture has been decoded;
selecting an intra-frame prediction method or an inter-frame prediction method based on the information about the method of generating a prediction block picture;
inferring a prediction direction for the current block from the neighboring block in order to configure a prediction picture; and
configuring the prediction picture for a current block picture in the inferred prediction direction.

3. The video decoding method of claim 2, wherein configuring the prediction picture for the current block picture is performed using at least one of a method of configuring an intra-frame prediction picture by copying or padding neighboring pixels neighboring the current block, a method of determining pixels to be copied by taking characteristics of neighboring pixels neighboring the current block into consideration and configuring the current block using the determined pixels, and a method of mixing a plurality of prediction methods and configuring a prediction block picture using an average value of values of the mixed prediction methods or a sum of weight according to each of the prediction methods.

4. A video decoding method for depth information, comprising:
generating a prediction block of a current block for the depth information;
generating a restored block of the current block based on the prediction block; and
performing filtering on the restored block,
wherein whether or not to perform the filtering is determined based on block information about the current block and coding information about the current block.

5. The video decoding method of claim 4, wherein:
the coding information comprises information about a part having an identical depth, a part being a background, and a part corresponding to an inside of an object within the restored image, and
the filtering is not performed on at least one of the part having the same depth, the part being the background, and the part corresponding to the part corresponding to the inside of the object within the restored block.

6. The video decoding method of claim 5, wherein at least one of a deblocking filter, a Sample Adaptive Offset (SAO) filter, an Adaptive Loop Filter (ALF), and In-loop Joint inter-View Depth Filtering (JVDF) is not performed on at least one of the part having the same depth, the part being the background, and the part corresponding to the part corresponding to the inside of the object within the restored block.

7. The video decoding method of claim 4, wherein:
the coding information comprises information about a part having an identical depth, a part being a background, and a part corresponding to an inside of an object within the restored image, and
weak filtering is performed on at least one of the part having the same depth, the part being the background, and the part corresponding to the part corresponding to the inside of the object within the restored block.

8. The video decoding method of claim 4, further comprising performing up-sampling on the restored block, wherein the up-sampling comprises padding one sample value with a predetermined number of sample values.

9. The video decoding method of claim 8, wherein the up-sampling is not performed in at least one of the part having the same depth, the part being the background, and the part corresponding to the inside of the object within the restored block.

10. The video decoding method of claim 4, wherein:
performing filtering on the restored block comprises:
determining boundary filtering strength for two neighboring blocks; and
applying the filtering to pixel values of the two neighboring blocks based on the boundary filtering strength, and
determining the boundary filtering strength comprises:
determining whether or not at least one of the two neighboring blocks has been intra-skip coded;
determining whether or not at least one of the two neighboring blocks has been intra-coded if, as a result of the determination, it is determined that both the two neighboring blocks have not been intra-skip coded;
determining whether or not at least one of the two neighboring blocks has an orthogonal transform coefficient if, as a result of the determination, it is determined that both the two neighboring blocks have not been intra-coded;
determining whether or not at least one of absolute values of a difference between x-axis components or y-axis components of a motion vector is 1 or 4 or higher or whether or not motion compensation has been performed based on different reference frames if, as a result of the determination, it is determined that both the two neighboring blocks do not have any orthogonal transform coefficient; and
determining whether or not all the absolute values of the difference between the x-axis components or the y-axis components of the motion vector is smaller than 1 or 4 and whether or not the motion compensation has been performed based on an identical reference frame.

11. The video decoding method of claim 10, wherein the boundary filtering strength is determined as 0 if, as a result of the determination, it is determined that at least one of the two neighboring blocks has been intra-skip coded.

12. The video decoding method of claim 10, wherein the boundary filtering strength is determined as any one of 1, 2, 3, and 4 if it is determined that one of the two neighboring blocks is in an intra-skip coding mode, the other of the two neighboring blocks is in a common intra-mode or inter-mode, and at least one orthogonal transform coefficient is present in the common intra-mode or inter-mode.

13. The video decoding method of claim 10, wherein the boundary filtering strength is determined as any one of 0, 1, 2, and 3 if it is determined that both the two neighboring blocks are in a common intra-mode or inter-mode and any orthogonal transform coefficient is not present in the common coding mode.

14. The video decoding method of claim 4, wherein if a prediction mode of the current block is an intra-skip mode not having difference information, generating the prediction block of the current block comprises inferring a prediction direction for the current block from neighboring blocks that neighbor the current block.

15. The video decoding method of claim 4, wherein:
performing filtering on the restored block comprises:
determining boundary filtering strength for two neighboring blocks; and
applying the filtering to pixel values of the two neighboring blocks based on the boundary filtering strength, and
determining the boundary filtering strength comprises determining the boundary filtering strength as 0 if a prediction direction for the current block is identical with a prediction direction of a neighboring block that neighbors the current block.

16. The video decoding method of claim 4, wherein:
performing filtering on the restored block comprises:
determining boundary filtering strength for two neighboring blocks; and
applying the filtering to pixel values of the two neighboring blocks based on the boundary filtering strength, and
determining the boundary filtering strength comprises:
setting the boundary filtering strength for a vertical boundary of the current block to 0 if a prediction mode of the current block is an intra-skip mode not having difference information and an intra-frame prediction direction for the current block is a horizontal direction; and
setting the boundary filtering strength for a horizontal boundary of the current block to 0 if a prediction mode of the current block is an intra-skip mode not having difference information and an intra-frame prediction direction for the current block is a vertical direction.

17. The video decoding method of claim 4, wherein:
performing filtering on the restored block comprises:
determining boundary filtering strength for two neighboring blocks; and
applying the filtering to pixel values of the two neighboring blocks based on the boundary filtering strength, and
determining the boundary filtering strength comprises setting the boundary filtering strength to 0 if boundaries of the current block and a neighboring block that neighbors the current block are identical with a boundary of a macro block.

18. A video decoding apparatus for depth information, comprising:
a prediction picture generation module for generating a prediction block of a current block for the depth information;
an addition module for generating a restored block of the current block based on the prediction block; and
a filter module for performing filtering on the restored block,
wherein the filter module comprises a boundary filtering strength determination module for determining boundary filtering strength for two neighboring blocks and a filtering application module for applying filtering to pixel values of the two neighboring blocks based on the boundary filtering strength.

19. The video decoding apparatus of claim 18, wherein the boundary filtering strength determination module determines the boundary filtering strength as 0 if at least one of the two neighboring blocks has been intra-skip coded.

20. The video decoding apparatus of claim 18, wherein the boundary filtering strength determination module determines the boundary filtering strength as any one of 1, 2, 3, and 4 if one of the two neighboring blocks is in an intra-skip coding mode, the other of the two neighboring blocks is in a common intra-mode or inter-mode, and at least one orthogonal transform coefficient is present in the common intra-mode or inter-mode.
